(19) United States
(12) Patent Application Publication
(10) Pub. No.: US 2018/0124672 A1
(43) Pub. Date: May 3, 2018

(54) METHOD, COMMUNICATION DEVICE AND COMMUNICATION SYSTEM

(71) Applicant: FUJITSU LIMITED, Kawasaki-shi (JP)

(72) Inventors: Yuya MURAKAMI, Yokohama (JP); Yoshio MIURA, Yokohama (JP); Noboru HASEGAWA, Oota (JP); Satoshi UEDA, Yokohama (JP); Kazunari KOBAYASHI, Yokohama (JP)

(73) Assignee: FUJITSU LIMITED, Kawasaki-shi (JP)

(21) Appl. No.: 15/726,044

(22) Filed: Oct. 5, 2017

(30) Foreign Application Priority Data
Oct. 28, 2016 (JP) 2016-211935

(51) Int. Cl. H04W 36/18; H04W 36/00; H04W 36/30

(52) U.S. Cl. CPC H04W 36/18; H04W 36/30; H04W 36/0094

(57) ABSTRACT

A method includes acquiring first information and second information from a terminal device, transmitting a second portion of data from the first storage device to a second storage device coupled to the second base station based on a determination to transfer the second portion of the data, determining whether to change a communication destination of a first communication of the terminal device from the first base station to the second base station based on the first information and the second information, changing the communication destination from the first base station to the second base station after the data is transmitted from the first storage device to the second storage device, and transmitting a segment of the second portion of the data from the second storage device to the terminal device after the communication destination is changed from the first base station to the second base station.

### CROSS-REFERENCE TO RELATED APPLICATION

This application is based upon and claims the benefit of priority of the prior Japanese Patent Application No. 2016-211935, filed on Oct. 28, 2016, the entire contents of which are incorporated herein by reference.

### FIELD

The embodiments discussed herein are related to a method, a communication device and a communication system.

### BACKGROUND

In recent years, a network centering on cloud computing is constructed and networking equipment such as a server or a data center that stores and manages a large volume of data is utilized.

In addition, services focusing on real-time performance of communications have been in widespread use these days. For example, in thin client service, while the mobile device side has minimum functions, the server side introduces an application to an operating system (OS) and an environment which is independent for each client is provided. When a system is provided in which a server transfers screen information to a mobile device and the mobile device transfers input information such as a flick operation to the server, emphasis is placed on the real-time performance of the system.

In order to place emphasis on the real-time performance of a system is proposed a system in which a base station is equipped with capability as a data center (which may also be referred to as an “edge DC (Data Center)”) and service is terminated between a mobile device and the base station. The termination of services between a mobile device and a base station enables services to be provided with less delay, in comparison with a case in which a mobile device exchanges data with a data center provided in a high-order Internet network through a base station. Prior art documents include Japanese Laid-open Patent Publication Nos. 2014-096831, 2013-201781, 2011-082699, and 2015-104000 and International Publication Pamphlet No. WO 2010/035835.

### SUMMARY

According to an aspect of the invention, a method includes performing a first communication between a first base station and a terminal device, wherein a first portion of data stored in a first storage device coupled to the first base station is transmitted to the terminal device in the first communication, acquiring, by the first base station, first information and second information from the terminal device, wherein the first information indicates a first reception intensity of a first signal transmitted from the first base station, the second information indicates a second reception intensity of a second signal transmitted from a second base station, and the first information and the second information are determined by the terminal device, transmitting, by the first base station, a second portion of the data from the first storage device to a second storage device coupled to the second base station based on a determination to transfer the second portion of the data, determining, by the first base station, whether to change a communication destination of the first communication of the terminal device from the first base station to the second base station based on the first information and the second information, changing the communication destination of the first communication of the terminal device from the first base station to the second base station after the data is transmitted from the first storage device to the second storage device, and transmitting, by the second base station, at least a segment of the second portion of the data from the second storage device to the terminal device after the communication destination is changed from the first base station to the second base station.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is diagram illustrating a configuration example of a communication system, together with a graph indicating a relation of a position of a mobile device and radio field strength;

FIG. 2 is a system configuration diagram illustrating a configuration example of the communication system illustrated in FIG. 1, including a configuration example of a core network;

FIG. 3 is a diagram illustrating an example of a protocol stack of the communication system illustrated in FIG. 2;

FIG. 4 is a sequence diagram describing an example of handover processing in the communication system in FIG. 1;

FIG. 5 is a sequence diagram describing an example of a handover sequence illustrated in FIG. 4;

FIG. 6 is a system configuration diagram illustrating a configuration example of a communication system;

FIG. 7 is a sequence diagram describing an example of handover processing in the communication system illustrated in FIG. 6;

FIG. 8 is a sequence diagram describing an example of the handover processing in the communication system illustrated in FIG. 6;

FIG. 9 is a system configuration diagram illustrating a configuration example of a communication system according to an embodiment;

FIG. 10 is a functional block diagram illustrating a functional configuration example of the communication system illustrated in FIG. 9;

FIG. 11 is diagram illustrating movement of a mobile device illustrated in FIG. 10 to a data transfer execution zone, together with a graph illustrating a relation of a position of the mobile device and radio field strength;

FIG. 12 is a table illustrating a judgment example on a data transfer operation illustrated in FIG. 11;

FIG. 13 is a diagram illustrating movement of the mobile device in the communication system illustrated in FIG. 10, when there are a plurality of edge DCs as a candidate for a data transfer destination;

FIG. 14 is graph illustrating a first example and a second example of a position of the mobile device and radio field strength in the example illustrated in FIG. 13;

FIG. 15 is a diagram illustrating a judgment example on the data transfer operation illustrated in FIGS. 13 and 14;

FIG. 16 is diagram illustrating a data transfer execution zone, a handover execution zone, and a forced handover execution zone, together with a graph illustrating a relation of a position of a mobile device and radio field strength;

FIG. 17 is a diagram illustrating a judgment example of the handover processing illustrated in FIG. 16;

FIG. 18 is a hardware configuration diagram illustrating a hardware configuration example of eNodeB (eNB) illustrated in FIG. 10;

FIG. 19 is a hardware configuration diagram illustrating a hardware configuration example of an edge DC illustrated in FIG. 10;

FIG. 20 is a hardware configuration diagram illustrating a hardware configuration example of the mobile device illustrated in FIG. 10;

FIG. 21 is a sequence diagram describing a data transfer operation example in the communication system illustrated in FIG. 10;

FIG. 22 is a sequence diagram describing details of the data transfer operation example illustrated in FIG. 21;

FIG. 23 is a flow chart describing a data transfer operation example in a data transfer processing unit in eNB at a data transfer source illustrated in FIG. 10;

FIG. 24 is a sequence diagram describing an updated data transfer operation example in the communication system illustrated in FIG. 10;

FIG. 25 is a sequence diagram describing the updated data transfer operation example in the communication system illustrated in FIG. 10;

FIG. 26 is a sequence diagram describing details of the updated data transfer operation example illustrated in FIGS. 24 and 25;

FIG. 27 is a sequence diagram describing details of the updated data transfer operation example illustrated in FIGS. 24 and 25;

FIG. 28 is a flowchart describing the updated data transfer operation example in a data processing unit of the edge DC at the data transfer source illustrated in FIG. 10;

FIG. 29 is a sequence diagram describing a handover processing example in the communication system illustrated in FIG. 10;

FIG. 30 is a sequence diagram describing details of the handover processing example illustrated in FIG. 29;

FIG. 31 is a sequence diagram describing details of the handover processing example illustrated in FIG. 29;

FIG. 32 is a flowchart describing a handover processing example in the data transfer processing unit of the eNB at a handover source illustrated in FIG. 10;

FIG. 33 is a sequence diagram describing a data deletion operation example in the communication system illustrated in FIG. 10;

FIG. 34 is a sequence diagram describing the data deletion operation example in the edge DC at the data transfer destination of the communication system illustrated in FIG. 10;

FIG. 35 is a flowchart describing a data deletion determination example for the edge DC at the data transfer destination in the eNB at the data transfer source illustrated in FIG. 10;

FIG. 36 is a sequence diagram illustrating the data deletion operation example in the edge DC at the data transfer source of the communication system illustrated in FIG. 10; and

FIG. 37 is a flowchart illustrating the data deletion determination example for the edge DC at the data transfer source in the eNB at the data transfer destination illustrated in FIG. 10.

### DESCRIPTION OF EMBODIMENTS

In a case in which a base station has capability as an edge DC, when a mobile device attempts to perform handover from a first base station to a second base station, there may arise a period of time during which service is not available. This service unavailable period occurs as data addressed to a certain mobile device is transferred from an edge DC provided in the first base station to an edge DC provided in the second base station at the timing when the mobile device hands over from the first base station to the second base station.

An embodiment is described hereinafter with reference to the drawings. However, the embodiment to be described below are only illustrative, and has no intention to exclude various variations or application of technologies that are not demonstrated in the embodiment. For example, the embodiment may be modified in various ways without departing from the spirit of the embodiment.

In addition, each figure is not intended to have only components illustrated in the figure, but may include other components. In the following, in the figures, parts assigned with a same symbol represent a same or similar part unless otherwise specified.

### [A] Related Example

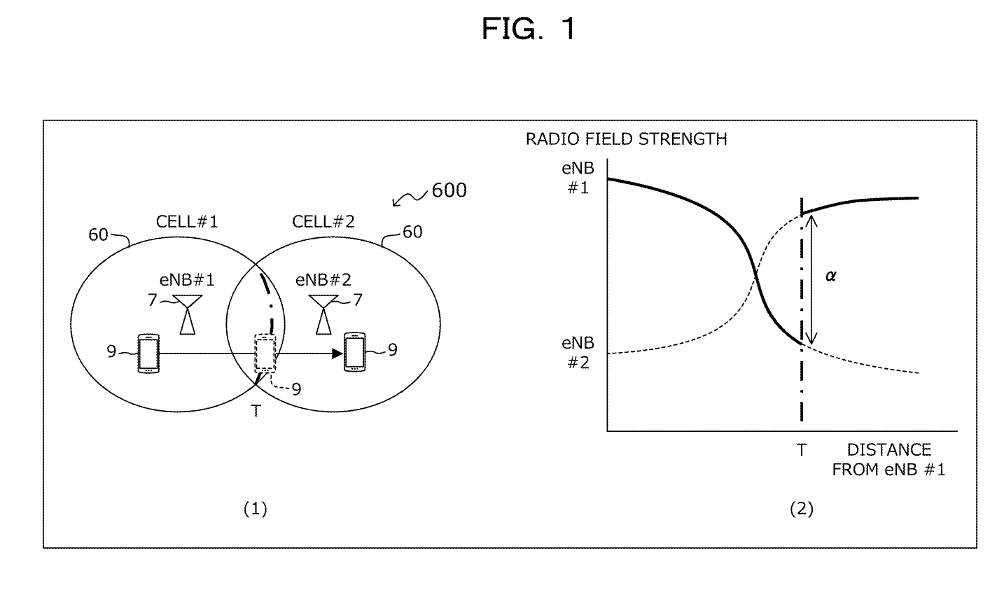

(1) of FIG. 1 is a diagram illustrating movement of a mobile device 9 from eNB #1 to eNB #2, and (2) of FIG. 1 is a graph illustrating a relation of a position of the mobile device and radio field strength.

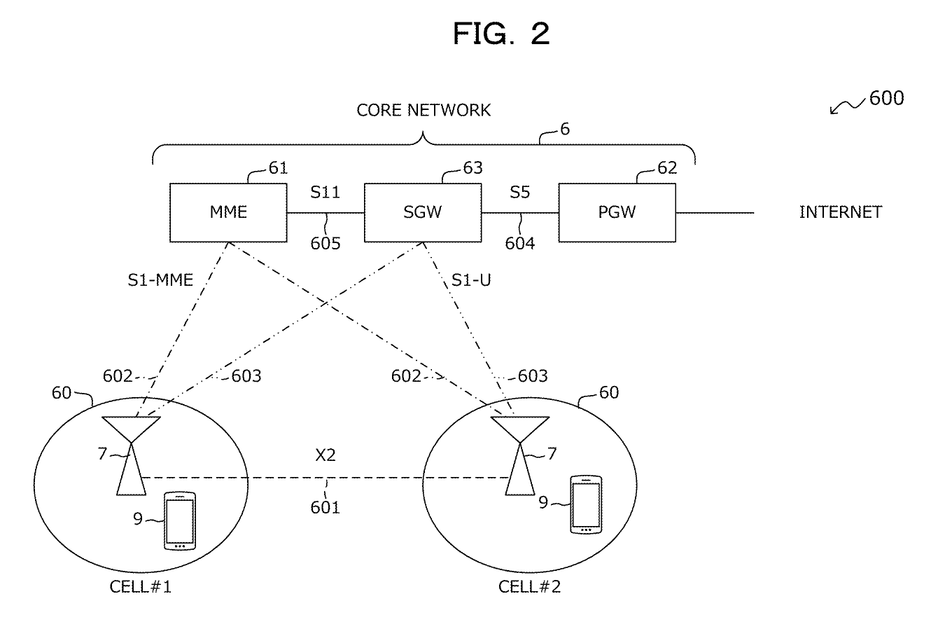

A communication system 600 illustrated in (1) of FIG. 1 illustratively includes two base stations 7 (which may also be referred to as “eNB #1” or “eNB #2”) and one mobile device (which may also be referred to as a “mobile terminal” or a “mobile station”) 9. In addition, the communication system 600 may include a core network 6, as described below with referring to FIG. 2 or the like.

The base stations 7 are illustratively connected to the mobile device 9 so that the base stations 7 may wirelessly communicate with the mobile device 9. The base stations 7 may provide a service area (which may also be referred to as a “cell”) 60 where the mobile device 9 may communicate.

The mobile device 9 is an example of communication equipment capable of wirelessly communicating with, for example, the base stations 7 in the cell 60 provided by the base stations 7.

In the example illustrated in (1) of FIG. 1, the eNB #1 provides a cell #1 and the eNB #2 provides a cell #2. In addition, in the example illustrated in (1) of FIG. 1, at least some area of the cell #1 mutually overlaps with at least some area of the cell #2.

Note that the cell 60 where the mobile device 9 is located may be referred to as Servicing Cell and the cell 60 adjacent to the Servicing Cell may be referred to as Neighbor Cell. More specifically, when the mobile device 9 is located in an area of the cell #1, the cell #1 is Servicing Cell and the cell #2 is Neighbor Cell.

Radio quality of the eNB #1 with which the mobile device 9 is in communication and the radio quality of the eNB #2 in a periphery where the mobile device 9 may receive a signal are measured, and the mobile device 9 may be handed over to the cell 60 having better radio quality.

Handover may be performed, triggered by an event flag of Measurement Control that is set for each carrier. An event flag may be set for each carrier, and may be set in consideration of control of a signal that is generated whenever handover is performed.

In the example illustrated in (1) of FIG. 1, the mobile device 9 moves from an area in the cell #1 provided by the eNB #1 to an area in the cell #2 provided by the eNB #2. When the mobile device 9 reaches a position T (see the dot-and-dash line in (1) of FIG. 1) which is distance T away from the eNB #1 in an overlapping area of the cell #1 and the cell #2, handover processing may be performed between the eNB #1 and the eNB #2. Upon completion of the handover processing, the eNB #1 stops communicating with the mobile device 9 and the eNB #2 starts communicating with the mobile device 9.

In the graph illustrated in (2) of FIG. 1, the horizontal axis represents distance from the eNB #1 to the mobile device 9, and the vertical axis represents radio field strength between the base stations 7 and the mobile device 9 that is measured by the mobile device 9.

As illustrated in (2) of FIG. 1, as distance between the eNB #1 and the mobile device 9 increases, the radio field strength between the eNB #1 and the mobile device 9 decreases. On the other hand, as distance between the eNB #1 and the mobile device 9 increases, the radio field strength between the eNB #2 and the mobile device 9 increases.

In an example illustrated in (2) of FIG. 1, when the distance between the eNB #1 and the mobile device 9 is T, and a difference between the radio field strength for the eNB #1 and the radio field strength for the eNB #2 is α or higher, handover processing is performed between the eNB #1 and the eNB #2.

FIG. 2 is a system configuration diagram illustrating a configuration example of the communication system 600 illustrated in FIG. 1, including a configuration example of the core network 6.

As illustratively illustrated in FIG. 2, the core network 6 may include an MME 61, a PGW 62, and an SGW 63. “MME” is stands for “Mobility Management Entity”. “PGW” is stands for “Packet data network GateWay”, and “SGW” is stands for “Serving GateWay”.

The core network 6 may also be referred to as the “backbone network 6” or “high-order network 6” for the base stations 7. The MME 61, the PGW 62, and the SGW 63 may be considered equivalent to an element (NE) or an entity of the “core network” and may be collectively referred to as a “core node”. A “core node” may also be considered equivalent to a “high-order” node of the base stations 7.

The base stations 7 may be connected to the core network 6 by an S1 interface, which is an example of a wired interface. Specifically, the base stations 7 may be connected to the MME 61 by an S1-MME interface 602. In addition, the base stations 7 may be connected to the SGW 63 by a user plan (S1-U) interface 603. However, the base stations 7 may also be connected to the core network 6 so that the base stations 7 may communicate with the core network 6 through a wireless interface.

A network including the base stations 7 and the core network 6 may also be referred to as a radio access network (RAN). An example of RAN is “Evolved Universal Terrestrial Radio Access Network, E-UTRAN”.

The SGW 63 may be connected to the PGW 62 through an interface called an S5 interface 604 so that the SGW 63 may communicate with the PGW 62. The PGW 62 may be connected to a packet data network (PDN) such as Internet or intranet or the like so that the PGW 62 may communicate with the packet data network.

A user packet may be transmitted and received between the mobile device 9 and a PDN by way of the PGW 62 and the SGW 63. A user packet is an example of user data and may also be referred to as a user plane signal.

Illustratively, the SGW 63 may process a user plane signal. A control plane signal may be processed by the MME 61. The SGW 63 may be connected to the MME 61 through an interface called an S11 interface 605 so that the SGW 63 may communicate with the MME 61.

The MME 61 illustratively manages position information of the mobile device 9. The SGW 63 may perform movement control such as path switching of a user plane signal as the mobile device 9 moves, based on the position information managed by the MME 61. The movement control may include control involved in handover of the mobile device 9.

The base stations 7 illustrated in FIG. 2 may be connected to be able to communicate through an inter-base station interface called an X2 interface 601. The inter-base station interface may be a wired interface or a wireless interface. As the mobile device 9 hands over, any packet that does not reach the mobile device 9 or information on the mobile device 9 may be transferred from the base stations 7 at a handover source to the base stations 7 at a handover destination through the X2 interface 601.

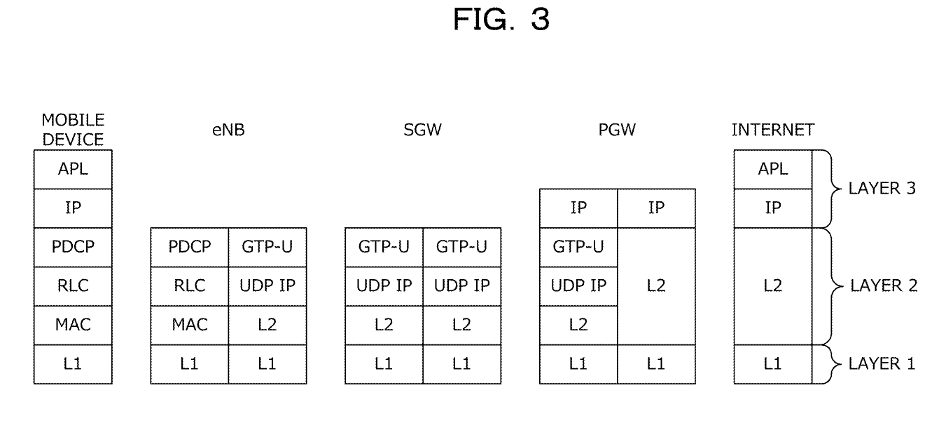

FIG. 3 is a diagram illustrating an example of a protocol stack of the communication system 600 illustrated in FIG. 2.

In a layer 1, communications may be performed between the mobile device 9, the base stations 7, the SGW 63, the PGW 62, and Internet, using L1 (which may also be referred to as a “physical layer”).

In a layer 2, communications may be performed between the mobile device 9 and the base stations 7, using MAC, radio link control (RLC), and a packet data convergence protocol (PDCP). In addition, in the layer 2, communications may be performed between the base stations 7 and SGW 63 and between SGW 63 and PGW 62, using L2, user datagram protocol/internet protocol (UDP IP), and GPRS tunneling protocol for user plane (GTP-U). Note that “GPRS” stands for “General Packet Radio Service”. Furthermore, in the layer 2, communications may be performed between the PGW 62 and Internet, using L2.

In a layer 3, communications may be performed between the mobile device 9 and the PGW 62 and between the PGW 62 and Internet, using internet protocol (IP). In addition, in the layer 3, communications may be performed between the mobile device 9 and Internet, using an application (APL).

As the mobile device 9 hands over, a packet that does not reach the mobile device 9 or information on the mobile device 9 may be transferred from the base stations 7 at the handover source to the base stations 7 at the handover destination by way of the X2 interface 601 (see FIG. 2), using the PDCP in the layer 2 illustrated in FIG. 3.

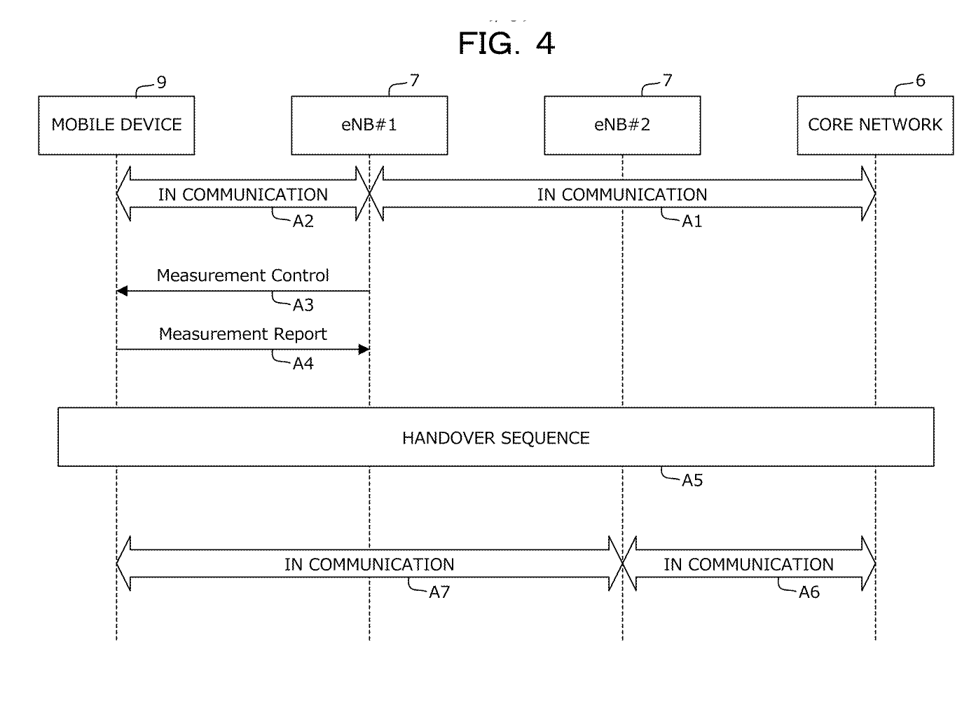

FIG. 4 is a sequence diagram describing handover processing illustrated in FIG. 1.

At symbols A1 and A2, the eNB #1 communicates with the core network 6 as well as with the mobile device 9. More specifically, the mobile device 9 is located in an area of the cell #1 provided by the eNB #1.

At symbol A3, the eNB #1 may transmit a Measurement Control signal to the mobile device 9.

At symbol A4, when receiving the Measurement Control signal, the mobile device 9 transmits a Measurement Report signal to the eNB #1. The Measurement Report signal transmitted at symbol A4 may include information indicating radio field strength between the mobile device 9 and the eNB #1 and radio field strength between the mobile device 9 and the eNB #2 that are measured by the mobile device 9. In addition, the Measurement Report signal transmitted at symbol A4 may indicate that a value obtained by subtracting the radio field strength between the mobile device 9 and the eNB #1 from the radio field strength between the mobile device 9 and the eNB #2 is α or higher.

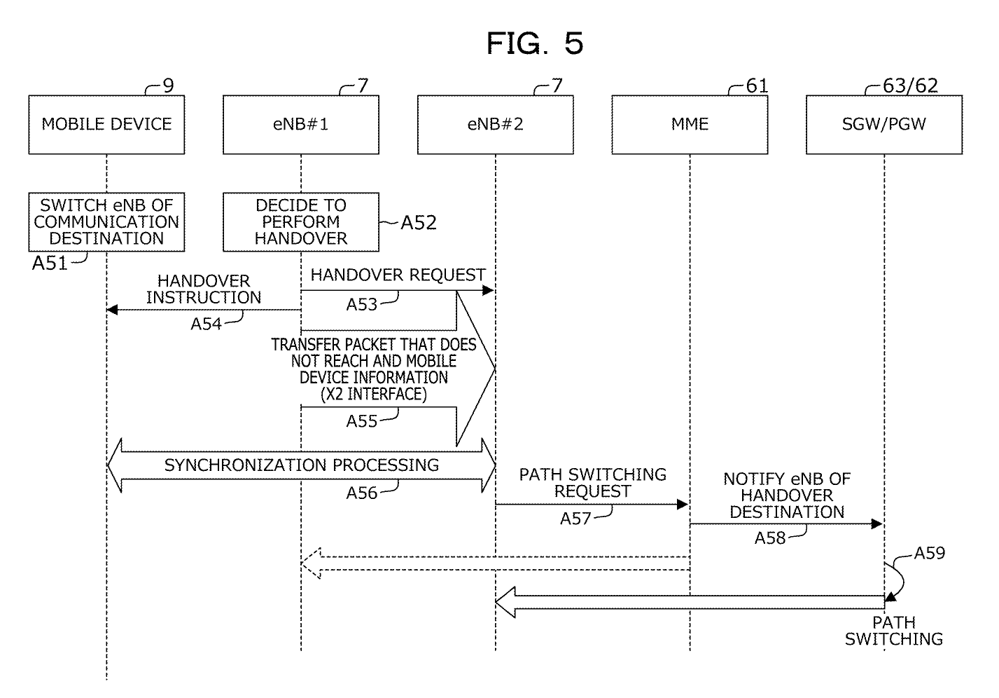

At symbol A5, the eNB #1 may perform a handover sequence to hand over the mobile device 9 to the cell #2 provided by the eNB #2, based on the received Measurement Report signal. Details of the handover sequence at symbol A5 is described below with referring to FIG. 5.

With the processing described above, at symbols A6 and A7, the eNB #2 may communicate with the core network 6 as well as with the mobile device 9.

FIG. 5 is a sequence diagram describing an example of the handover sequence illustrated in FIG. 4.

At symbol A51, the mobile device 9 may switch base stations 7 at a communication destination from the eNB #1 to the eNB #2.

At symbol A52, the eNB #1 may decide to perform handover.

At symbol A53, the eNB #1 may issue a handover request to the eNB #2.

At symbol A54, the eNB #1 may issue a handover instruction to the mobile device 9.

At symbol A55, the eNB #1 may transfer a packet that does not reach the mobile device 9 and information on the mobile device 9 to the eNB #2, by way of the X2 interface 601 (see FIG. 2).

At symbol A56, the mobile device 9 and the eNB #2 may perform synchronization processing.

At symbol A57, the eNB #2 may issue to the MME 61 a request to switch a path to the mobile device 9 from by way of the eNB #1 to by way of the eNB #2.

At symbol A58, the MME 61 may notify the SGW 63 and the PGW 62 that the base stations 7 at the handover destination of the mobile device 9 is the eNB #2.

At symbol A59, the SGW 63 and the PGW 62 may switch the path to the mobile device 9 from by way of the eNB #1 to by way of the eNB #2.

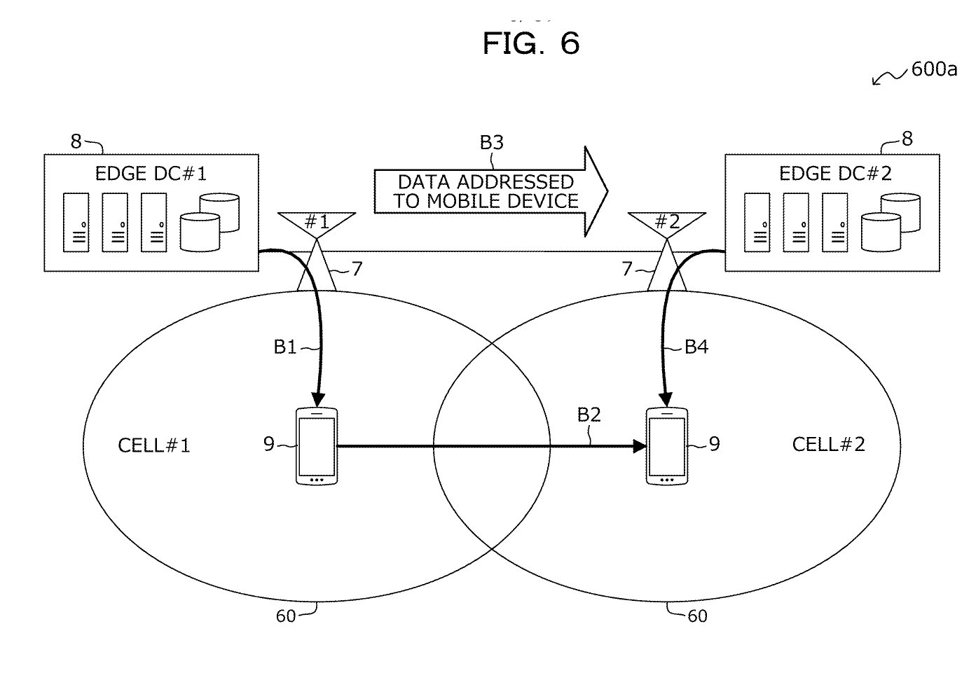

FIG. 6 is a system configuration diagram illustrating a configuration example of a communication system 600a.

The communication system 600a illustrated in FIG. 6 illustratively includes two edge DCs 8 (which may also be referred to as an “edge DC #1” or an “edge DC #2”), in addition to a functional configuration that the communication system 600 illustrated in (1) of FIG. 1 has.

An edge DC 8 illustratively stores user data such as application data or the like that is used by the mobile device 9. In addition, the edge DC #1 and edge DC #2 may be connected to communicate with each other by way of Ethernet®, for example. In the example illustrated in FIG. 6, the edge DC #1 provides data to the mobile device 9 by way of the eNB #1 and the edge DC #2 provides data to the mobile device 9 by way of the eNB #2.

The edge DC 8 may be provided in each the base station 7 to improve the real-time performance in the thin client service. In comparison with a case in which communication with a data center present in a high-order Internet network is performed by way of the base stations 7, service with less delay may be provided since the service is terminated at the base stations 7.

In the thin client service, it is assumed that data tied with an individual such as word-processing software or spreadsheet software, moving image data or the like is transmitted and received between the mobile device 9 and the base stations 7.

Handover processing at the communication system 600a that provides the thin client service is described hereinafter.

As illustrated at symbol B1, the edge DC #1 may provide application data to the mobile device 9 located in an area of the cell #1 formed by the eNB #1, by way of the eNB #1.

As illustrated at symbol B2, when the mobile device 9 moves from an area in the cell #1 to an area in the cell #2, handover of the mobile device 9 may be performed between the eNB #1 and the eNB #2.

As illustrated at symbol B3, the edge DC #1 may transfer the application data addressed to the mobile device 9 to the edge DC #2.

As illustrated at symbol B4, the edge DC #2 may provide data to the mobile device 9 located in the area in the cell #2 formed by the eNB #2, by way of the eNB #2.

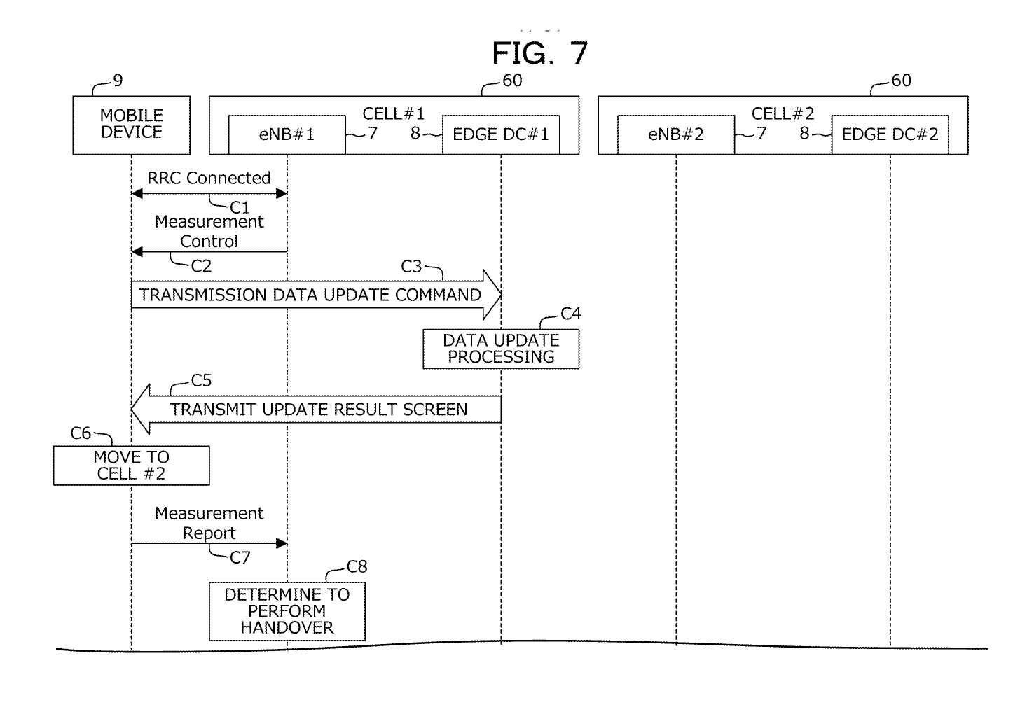

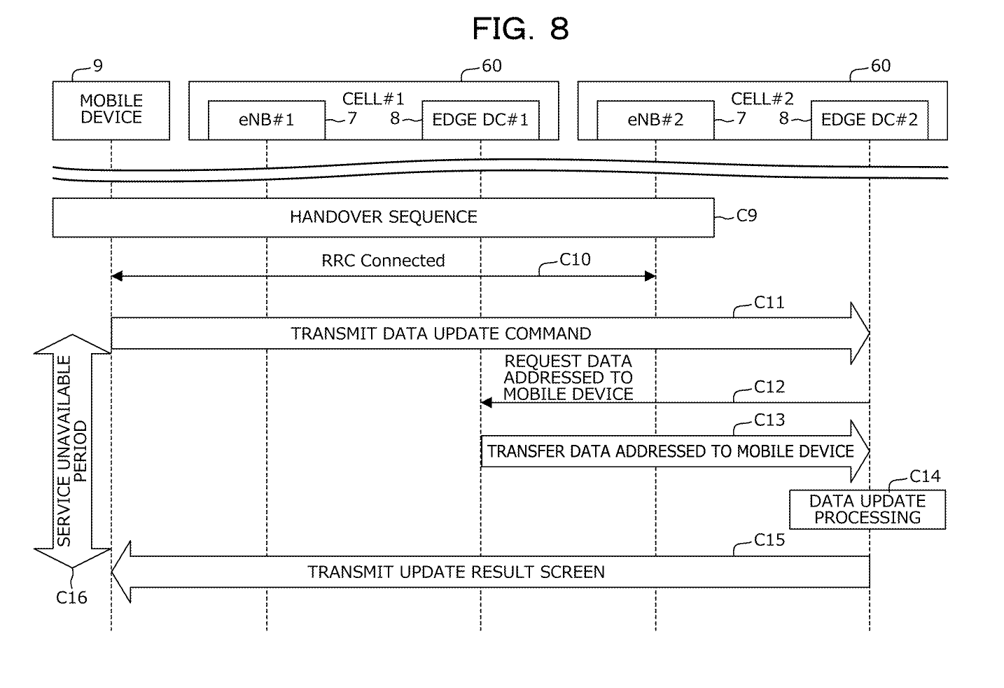

FIGS. 7 and 8 are a sequence diagram describing the handover processing in the communication system 600a illustrated in FIG. 6.

As illustrated at symbol C1 in FIG. 7, the mobile device 9 may establish RRC Connected with the eNB #1 that provides the cell #1. Note that “RRC” stands for “Radio Resource Control”.

At symbol C2 in FIG. 7, the eNB #1 may transmit a Measurement Control signal to the mobile device 9.

At symbol C3 in FIG. 7, the mobile device 9 may transmit a data update command to the edge DC #1 by way of the eNB #1.

At symbol C4 in FIG. 7, the edge DC #1 may perform data update processing based on the received data update command.

At symbol C5 in FIG. 7, the edge DC #1 may transmit information for displaying an update result screen to the mobile device 9, by way of the eNB #1.

At symbol C6 in FIG. 7, the mobile device 9 may move from the area in the cell #1 into the area of the cell #2.

At symbol C7 in FIG. 7, the mobile device 9 may transmit a Measurement Report signal to the eNB #1.

At symbol C8 in FIG. 7, the eNB #1 may determine whether to perform handover, based on the received Measurement Report signal. In the example illustrated at symbol C8 in FIG. 7, the eNB #1 determines to perform handover.

At symbol C9 in FIG. 8, the eNB #1 may perform a handover sequence to hand over the mobile device 9 to the cell #2 provided by the eNB #2.

At symbol C10 in FIG. 8, the mobile device 9 may establish RRC connected with the eNB #2 that provides the cell #2.

At symbol C11 in FIG. 8, the mobile device 9 may transmit a data update command to the edge DC #2 by way of the eNB #2.

At symbol C12 in FIG. 8, since the edge DC #2 does not hold application data addressed to the mobile device 9, the edge DC #2 may request the edge DC #1 for the application data addressed to the mobile device 9.

At symbol C13 in FIG. 8, the edge DC #1 may transfer the application data of the mobile device 9 to the edge DC #2.

At symbol C14 in FIG. 8, the edge DC #2 may perform data update processing based on the received application data of the mobile device 9.

At symbol C15 in FIG. 8, the edge DC #2 may transmit to the mobile device 9 information for displaying the update result screen by way of the eNB #2.

As illustrated at symbol C16 in FIG. 8, a period from when the data update command is transmitted from the mobile device 9 to the edge DC #2 till when the information for displaying the update result screen is transmitted from the edge DC #2 to the mobile device 9 becomes a service unavailable period.

In the communication system 600a that performs wireless communications, since it is likely that handover processing is performed frequently, a service unavailable period may also occur frequently. For example, when application data addressed to the mobile device 9 is 32 GB and a file transfer rate between the edge DCs 8 is 1 Gbps, a service unavailable period of 256 seconds occurs even if only a data transfer period is considered.

### [B] Embodiment

### [B-1] Hardware Configuration Example

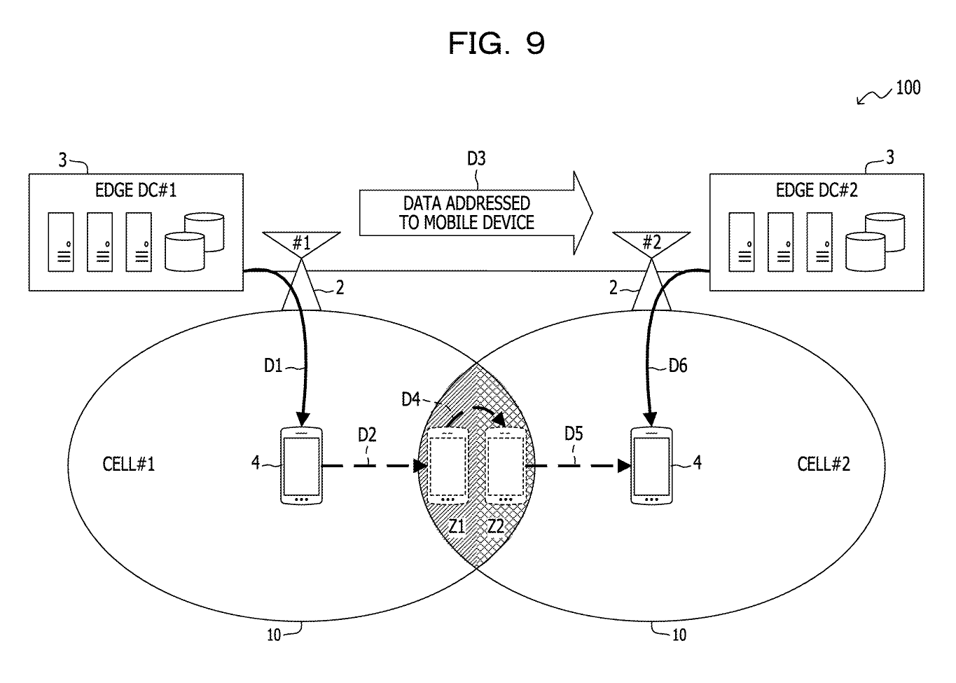

FIG. 9 is a system configuration diagram illustrating a configuration example of a communication system 100 of an embodiment.

The communication system 100 illustratively includes a plurality of (two in the illustrated example) base stations 2, a plurality of (two in the illustrated example) edge DCs 3, and one or more (one in the illustrated example) mobile devices 4.

Note that the “base stations 2” illustrated in FIG. 9 may also be referred to as an “eNB #1” or an “eNB #2”. In addition, the “edge DCs 3” illustrated in FIG. 9 may also be referred to as “data centers 3” or “data processors 3”, “edge DC #1” or “edge DC #2”. Furthermore, the “mobile device 4” may also be referred to as a “mobile station 4”, a “mobile terminal 4”, or a “user equipment (UE) 4”.

The eNB #2 is illustratively connected to the mobile device 4 so that the eNB #2 may wirelessly communicate with the mobile device 4. The eNB #2 may provide a service area (which may also be referred to as a “cell”) 10 where the mobile device 4 may communicate.

The edge DCs 3 illustratively store user data such as application data or the like to be used by the mobile device 4. In addition, the edge DCs #1 and #2 may be connected to be able to communicate with each other by way of Ethernet®, for example. In the example illustrated in FIG. 9, the edge DC #1 provides data to the mobile device 4 by way of the eNB #1, and the edge DC #2 provides data to the mobile device 4 by way of the eNB #2. Note that a function as the edge DC 3 may be embedded in the eNB #2.

The mobile device 4 is an example of communication equipment capable of wirelessly communicating with the eNB #2 in the cell 10 provided by the eNB #2, for example.

In the example illustrated in FIG. 9, the eNB #1 provides a cell #1 and the eNB #2 provides a cell #2. In addition, in the example illustrated in FIG. 1, at least some area of the cell #1 mutually overlaps with at least some area of the cell #2.

The cell 10 may be formed by setting transmission power for each eNB #2 or the like, or may be formed with statistical data in a Measurement Report collected from the mobile device 4.

Note that the cell 10 where the mobile device 4 is located may be referred to as Servicing Cell and the cell 10 adjacent to Serving Cell may be referred to as Neighbor Cell. More specifically, when the mobile device 4 is located in an area of the cell #1, the cell #1 is Serving Cell and the cell #2 is Neighbor Cell.

As illustrated in FIG. 9, a data transfer execution zone Z1 and a handover execution zone Z2 may be set in at least a part of the area where the area of the cell #1 overlaps with the area of the cell #2. When the mobile device 4 reaches the data transfer execution zone Z1, data addressed to the mobile device 4 stored in the edge DC #2 may be transferred to the edge DC #2. In addition, when the mobile device 4 reaches the handover execution zone Z2, the eNB #1 may hand over the mobile device 4 from the cell #1 to the cell #2.

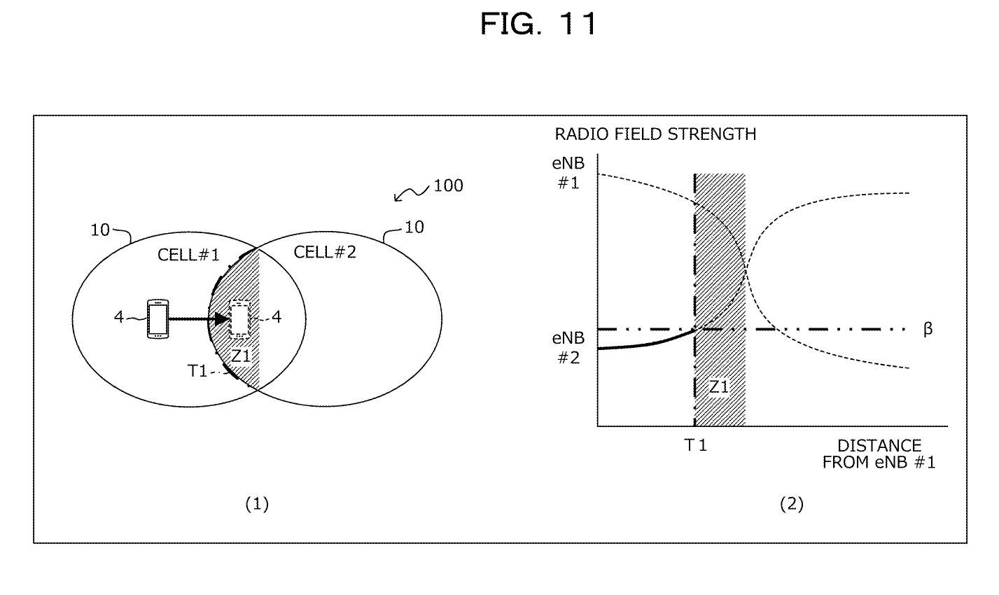

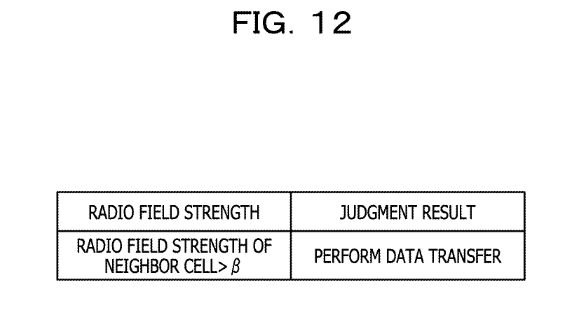

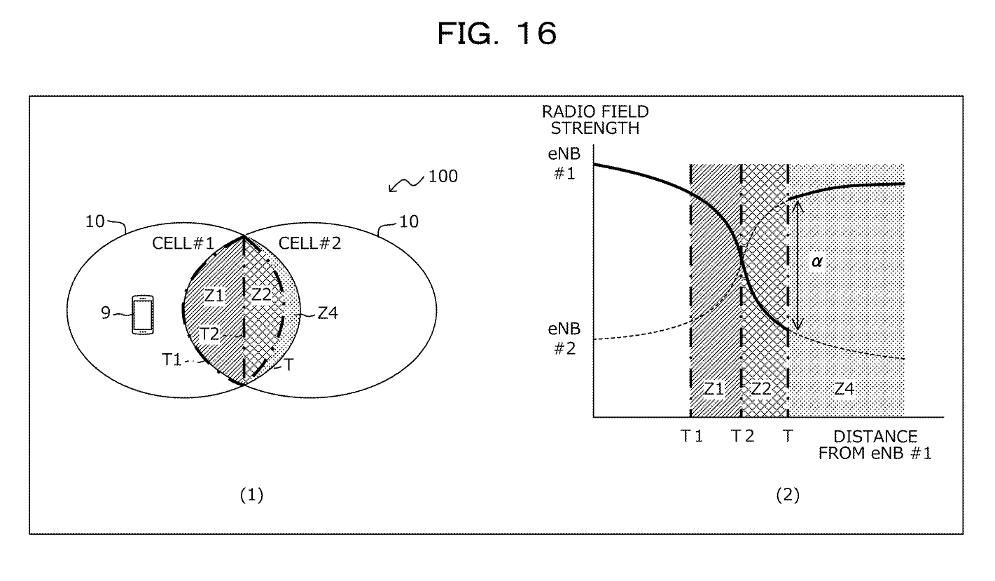

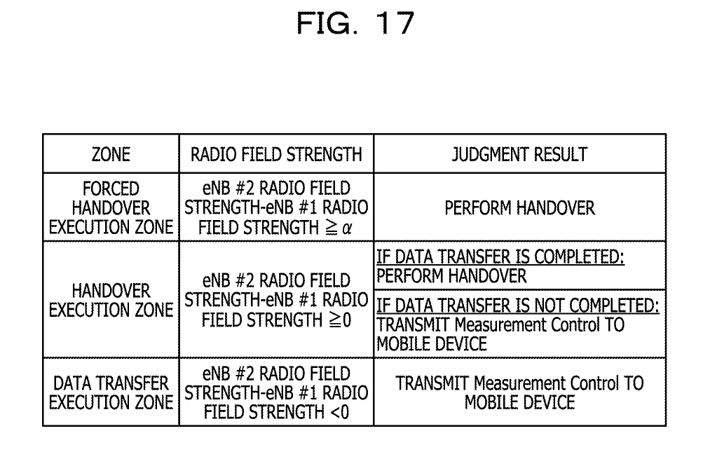

Details of the data transfer execution zone Z1 are described below with referring to FIGS. 11 and 12. In addition, details of the handover execution zone Z2 are described below with referring to FIGS. 16 and 17.

As illustrated at symbol D1, the edge DC #1 may provide application data to the mobile device 4 located in an area of the cell #1 where the eNB #1 is deployed, by way of the eNB #1.

As illustrated at symbol D2, when the mobile device 4 moves from neighborhood of the center of the cell #1 to the data transfer execution zone Z1, as illustrated at symbol D3, the edge DC #1 may transfer application data addressed to the mobile device 4 to the edge DC #2. Transfer of the application data may be performed, using the IP in the layer 3 illustrated in FIG. 3.

As illustrated at symbol D4, when the mobile device 4 moves from the data transfer execution zone Z1 to the handover execution zone Z2, handover of the mobile device 4 may be performed between the eNB #1 and the eNB #2.

Furthermore, as illustrated at symbol D5, the mobile device 4 may move from the handover execution zone Z2 to neighborhood of the center of the cell #2. With this, as illustrated at symbol D6, the edge DC #2 may provide data to the mobile device 4 located in the area of the cell #2 formed by the eNB #2, by way of the eNB #2.

Note that the edge DC 3 may not be provided in each cell 10 and may be shared by a plurality of adjacent cells 10 (in other words, “eNB #2”). In this case, transfer of the application data addressed to the mobile device 4 may be performed, before handover processing is performed between two eNBs #2 that do not share the edge DC 3.

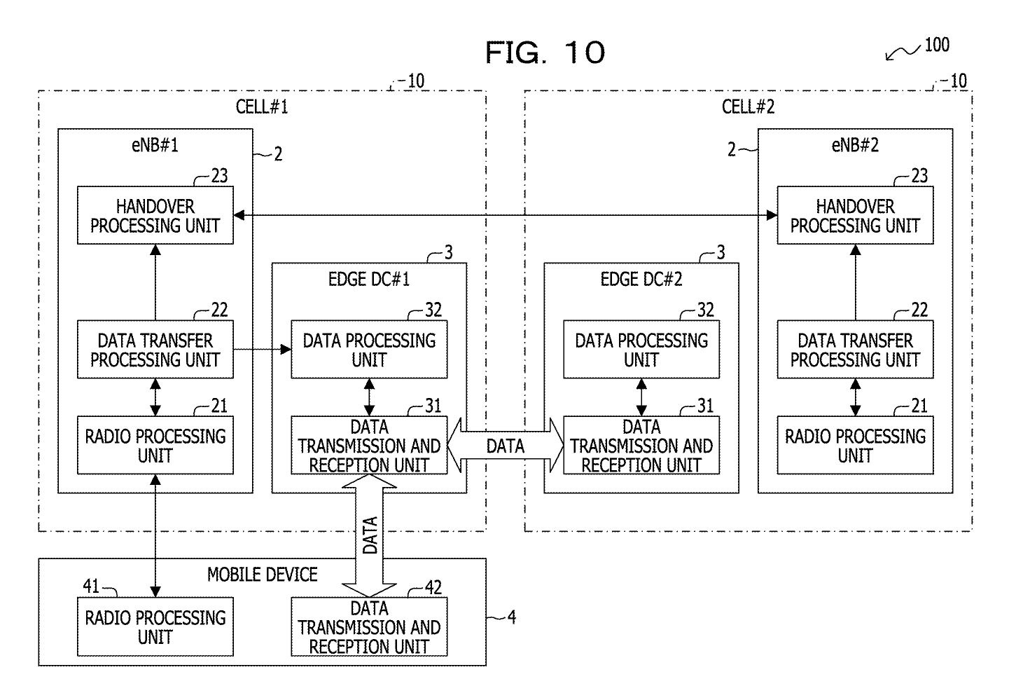

FIG. 10 is a functional block diagram illustrating a functional configuration diagram of the communication system 100 illustrated in FIG. 9.

The mobile device 4 illustratively includes functions as a radio processing unit 41 and a data transmission and reception unit 42.

The radio processing unit 41 illustratively performs transmission and reception of a radio signal to and from the eNB #2. The radio processing unit 41 may also measure the radio quality with each eNB #2 and report information indicating the measured radio quality to the eNB #2 in Serving Area (the cell #1 in the example illustrated in FIG. 10). The information indicating the radio quality may be radio field strength or a bit error rate.

The data transmission and reception unit 42 illustratively performs transmission and reception of application data to and from the edge DC 3 by way of the radio processing unit 41 and the eNB #2.

The edge DC 3 illustratively has capability as a data transmission and reception unit 31 and a data processing unit 32.

The data transmission and reception unit 31 illustratively performs transmission and reception of application data to and from the mobile device 4, by way of the eNB #2. The data transmission and reception unit 31 may also transfer to other edge DC 3 application data which is related to a data transfer request and addressed to the mobile device 4, based on the data transfer request from the eNB #2 by way of the data processing unit 32. For example, when receiving from the eNB #1 a data transfer request for the application data addressed to the mobile device 4, the edge DC #1 transfers to the edge DC #2 the application data addressed to the mobile device 4.

When receiving the data transfer request from the eNB #2, the data processing unit 32 illustratively transfers the data transfer request to the data transmission and reception unit 31. In addition, the data processing unit 32 may perform various processing based on the application data that the data transmission and reception unit 31 received from the mobile device 4.

When there is transmission of the application data by the mobile device 4 after a data transfer operation by the data transmission and reception unit 31 is started, the data processing unit 32 determines whether to transfer data after being updated to other edge DC 3. For example, if application data by the mobile device 4 indicates entered character information, the data processing unit 32 may determine that the data after being updated is transferred to other edge DC 3, and instruct the data transmission and reception unit 31 to transfer the data after being transferred. On the other hand, when the application data by the mobile device 4 is movement of a mouse pointer, a click operation, or a file save operation or the like, the data processing unit 32 may also determine that the data after being updated is not transferred to the other edge DC 3.

If size of the data after being updated is larger than a threshold, the data processing unit 32 may transfer a difference between the data after being updated and the data before being updated to the other edge DC 3.

With this, even if data addressed to the mobile device 4 is updated during data transfer processing, delay time till service starts in the cell 10 at the handover destination may be reduced.

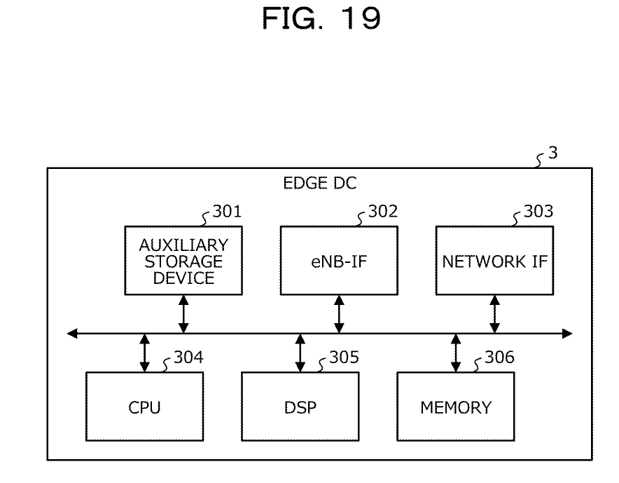

When receiving a data deletion request from the other edge DC 3, the data processing unit 32 may delete application data addressed to the mobile device 4 which is related to the deletion request and stored in an auxiliary storage device 301 (to be described with referring to FIG. 19). For example, when the mobile device 4 moves to the central part of the cell #2 of the handover destination and radio field strength between the eNB #1 and the mobile device 4 falls below a fourth threshold, the data processing unit 32 of the edge DC #1 may receive a data deletion request. In addition, when the mobile device 4 moves (“returns”, in other words) to the central part of the cell #1 of the handover source, for example, and radio field strength between the eNB #2 and the mobile device 4 falls below the fourth threshold, the data processing unit 32 of the edge DC #2 may receive the data deletion request.

The following thresholds are used herein.

First threshold: When the radio field strength between the eNB #2 at the handover destination and the mobile device 4 exceeds the threshold, data transfer processing is performed (to be elaborately described with referring to FIG. 11, 12, or the like; the first threshold may also be referred to as a “predetermined value” or a “first predetermined value”).

Second threshold: When the radio field strength between the eNB #2 at the handover destination and the mobile device 4 exceeds the threshold, handover processing is performed (to be elaborately described with referring to FIG. 11, 12, or the like; the second threshold may also be referred to as a “second predetermined value”).

Third threshold: When a value obtained by subtracting the radio field strength for the eNB #2 at the handover source from the radio field strength of the eNB #2 at the handover destination exceeds the threshold, forced handover processing is performed (to be elaborately described with referring to FIG. 16, 17, or the like; the third threshold may also be referred to as a “third predetermined value”).

Fourth threshold: When the radio field strength between the eNB #2 at the handover source and the mobile device 4 falls below the threshold, data deletion processing is performed in the edge DC 3 at the handover source. When the radio field strength between the eNB #2 at the handover destination and the mobile device 4 falls below the threshold, data deletion processing is performed in the edge DC 3 at the handover destination (the fourth threshold may also be referred to as a “fourth predetermined value”).

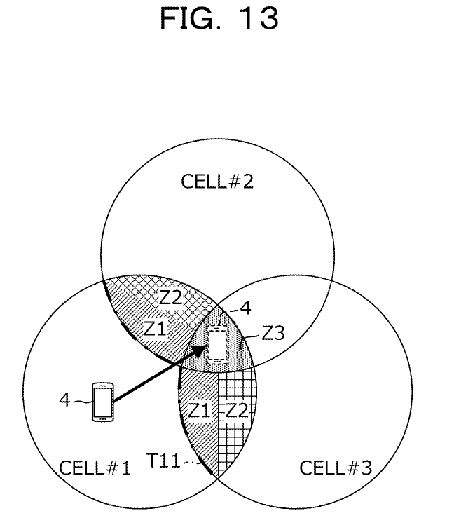

Fifth threshold: When an absolute value of a difference between the radio field strength for the eNB #2 at a plurality of handover destination candidates is less than the threshold, data transfer processing is performed on the edge DC 3 of the plurality of handover destination candidates (to be elaborately described with referring to FIG. 13, 14, 15, or the like; the fifth threshold may also be referred to as a “fifth predetermined value”).

When receiving a deletion request for the other edge DC 3 from the eNB #2, the data processing unit 32 may transfer the deletion request to the other edge DC 3.

The eNB #2 illustratively includes functions as a radio processing unit 21, a data transfer processing unit 22, and a handover processing unit 23.

The radio processing unit 21 illustratively performs transmission and reception of a radio signal to and from the mobile device 4. In addition, the radio processing unit 21 may function as an example of a receiving unit that receives information indicating the radio quality to be reported from the mobile device 4.

The data transfer processing unit 22 illustratively judges whether to transfer application data addressed to the mobile device 4 to the edge DC 3 belonging to other cell 10, based on the information indicating the radio quality that is received by the radio processing unit 21.

When the radio field strength between the other eNB #2 and the mobile device 4 falls below the fourth threshold, the data transfer processing unit 22 may issue a data deletion request to the edge DC 3 belonging to the other cell 10, by way of the edge DC 3 belonging to the same cell 10.

With this, a resource at the edge DC 3 may be effectively utilized.

Details of the data transfer processing unit 22 are described below with referring to FIG. 11, 12, 13, 14, 15, 16, 17, or the like.

The handover processing unit 23 illustratively determines whether to hand over the mobile device 4 to other eNB #2, based on the information indicating the radio quality that is received by the radio processing unit 21. When the handover processing unit 23 determines to hand over, the handover processing unit 23 may perform a handover sequence (which may also be referred to as “handover processing”) in cooperation with the handover processing unit 23 of the other eNB #2. Details of the handover processing unit 23 are described below with referring to FIG. 16, 17, or the like.

(1) of FIG. 11 is a diagram illustrating movement of the mobile device 4 illustrated in FIG. 10 to the data transfer execution zone Z1, and (2) of FIG. 11 is a graph illustrating a relation of a position of the mobile device 4 illustrated in (1) of FIG. 11 and radio field strength. FIG. 12 is a table illustrating a judgment on the data transfer operation illustrated in FIG. 11.

As illustrated in (1) of FIG. 11, the mobile device 4 moves from neighborhood of the center of the cell #1 to the data transfer execution zone Z1.

In the graph illustrated in (2) of FIG. 11, the horizontal axis represents distance from the eNB #1 to the mobile device 4, and the vertical axis represents radio field strength between the eNB #2 and the mobile device 4 that is measured by the mobile device 4.

As illustrated in (2) of FIG. 11, as distance between the eNB #1 and the mobile device 4 increases, the radio field strength between the eNB #1 and the mobile device 4 decreases. On the other hand, as the distance between the eNB #1 and the mobile device 4 increases, the radio field strength between the eNB #2 and the mobile device 4 increases.

In the example illustrated in (2) of FIG. 11, if the distance between the eNB #1 and the mobile device 4 exceeds T1 and the radio field strength between the eNB #2 and the mobile device 4 is larger than β (which may also be referred to as the “first threshold”), transfer of data addressed to the mobile device 4 to the edge DC #2 belonging to the cell #2 may be performed.

More specifically, as illustrated in FIG. 12, when the radio field strength of the neighbor cell 10 exceeds β, the data transfer processing unit 22 may judge that transfer of the data addressed to the mobile device 4 to the edge DC 3 belonging to the other cell 10 is performed.

In other words, when the radio field strength is larger than the first threshold (which may also be referred to as a “predetermined value”), the data transfer processing unit 22 may request the edge DC #1 to transfer data to be used in application to the edge DC #2. In addition, after the transfer is completed, the handover processing unit 23 may hand over the mobile device 4 to the cell #2 formed by the eNB #2, based on the radio field strength.

With this, since the application data addressed to the mobile device 4 is transferred to the eNB #2 at the handover destination before handover processing is performed, delay in service while handover is performed may be reduced. Then, continuity of service while handover is performed may be secured.

In addition, when the value obtained by subtracting the radio field strength for the eNB #2 from the radio field strength for the eNB #1 falls below the threshold, the data transfer processing unit 22 may also judge that transfer of the data addressed to the mobile device 4 to the edge DC #2 is performed.

As illustrated in (1) of FIG. 11, the distance T1 may be determined based on distance from the eNB #1 to the end of the cell #2.

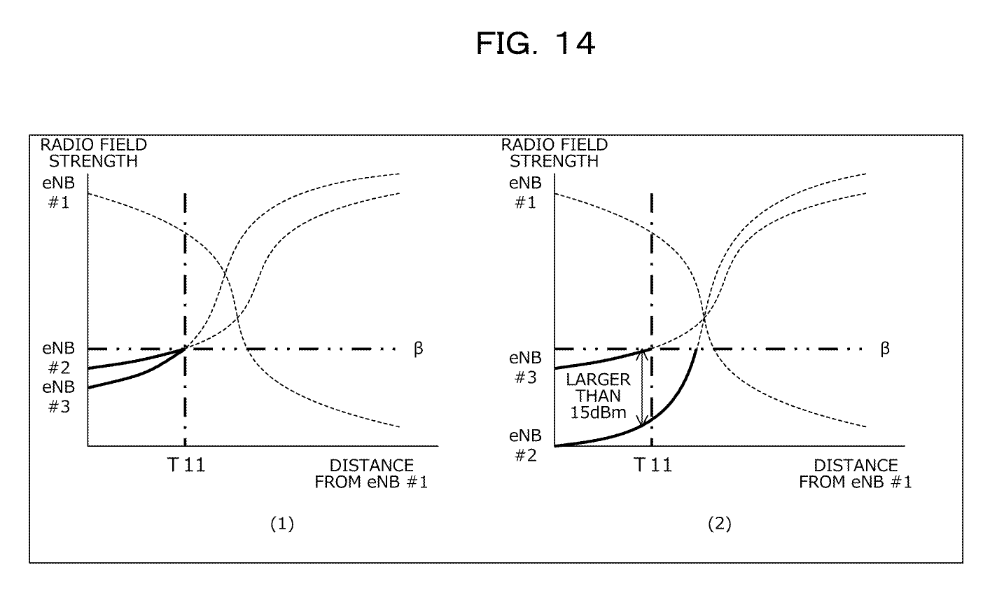

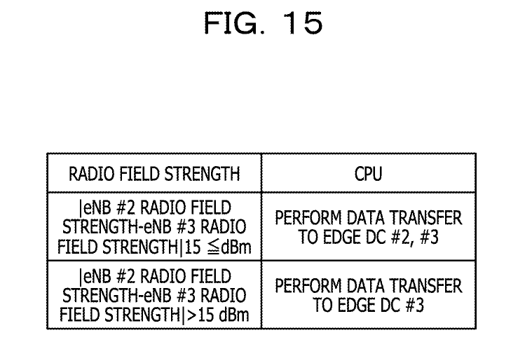

FIG. 13 is a diagram illustrating movement of the mobile device 4 in the communication system 100 illustrated in FIG. 10, when there are a plurality of edge DCs 3 as a candidate for a data transfer destination. (1) of FIG. 14 is a graph illustrating a first example of a position of the mobile device 4 and radio field strength in the example illustrated in FIG. 13, and (2) of FIG. 14 is graph illustrating a second example of a position of the mobile device 4 and the radio field strength in the example illustrated in FIG. 13. FIG. 15 is a diagram illustrating a judgment example on the data transfer operation illustrated in FIGS. 13 and 14.

In the example illustrated in FIG. 13, three cells #1 to #3 are formed. At least some area of the cell #1, at least some area of the cell #2, and at least some area of the cell #3 overlap with each other to form an area Z3.

As illustrated in FIG. 13, the mobile device 4 moves from neighborhood of the center of the cell #1 to the area Z3.

In the graphs illustrated in FIG. 14, the horizontal axis represents distance from the eNB #1 to the mobile device 4, and the vertical axis represents radio field strength between the eNB #2 and the mobile device 4 that is measured by the mobile device 4.

As illustrated in FIG. 14, as the distance between the eNB #1 and the mobile device 4 increases, the radio field strength between the eNB #1 and the mobile device 4 decreases. On the other hand, as the distance between the eNB #1 and the mobile device 4 increases, the radio field strength between the eNB #2 and the mobile device 4 and the radio field strength between the eNB #3 and the mobile device 4 increase.

In the example illustrated in (1) of FIG. 14, when the distance between the eNB #1 and the mobile device 4 exceeds T11, the radio field strength between the eNB #2 and the mobile device 4 and the radio field strength between the eNB #3 and the mobile device 4 are larger than β. In addition, in the example illustrated in (1) FIG. 14, the difference between the radio field strength for the eNB #2 and the radio field strength for the eNB #3 is less than the fifth threshold (for example, 15 dBm), when the distance between the eNB #1 and the mobile device 4 is T11. In this case, transfer of the data addressed to the mobile device 4 to the edge DC #2 belonging to the cell #2 and the edge DC #3 belonging to the cell #3 may be performed.

More specifically, as illustrated in FIG. 15, the data transfer processing unit 22 judges whether the radio field strength of a plurality of neighbor cells 10 exceed β and an absolute value of the difference of a plurality of radio field strength is a threshold (for example, 15 dBm) or smaller. Then, when the conditions are satisfied, the data transfer processing unit 22 may judge that transfer of the data addressed to the mobile device 4 to the plurality of edge DCs 3 (for example, the edge DCs #2 and #3) belonging to the other cell 10 is performed.

With this, delay in service while handover is performed may be reduced, even if there are a plurality of eNBs #2 that are a candidate for a handover destination.

In the example illustrated in (2) of FIG. 14, when the distance between the eNB #1 and the mobile device 4 exceeds T11, the radio field strength between the eNB #3 and the mobile device 4 is larger than β. In addition, in the example illustrated in (2) of FIG. 14, an absolute value of a difference between the radio field strength for the eNBs #2 and the radio field strength for the eNBs #3 when the distance between the eNB #1 and the mobile device 4 is T11 is larger than the fifth threshold (for example, 15 dBm). In this case, transfer of the data addressed to the mobile device 4 to the edge DC #3 belonging to the cell #3 with the maximum radio field strength is performed.

More specifically, as illustrated in FIG. 15, the data transfer processing unit 22 judges whether the radio field strength of the plurality of neighbor cells 10 exceeds β and the absolute value of the difference of the plurality of radio field strength is below the threshold (for example, 15 dBm). Then, if the judgment conditions are not satisfied, the data transfer processing unit 22 may judge that the transfer of the data addressed to the mobile device 4 to the edge DC 3 (for example, edge DC #3) belonging to other cell 10 with the maximum radio field strength is performed.

(1) of FIG. 16 is a diagram illustrating the data transfer execution zone Z1, the handover execution zone Z2, and the forced handover execution zone Z4, and (2) of FIG. 16 is a graph illustrating a relation of a position of the mobile device 4 illustrated in (1) of FIG. 16 and radio field strength. FIG. 17 is a diagram illustrating a judgment example of the handover processing illustrated in FIG. 16.

As illustrated in (1) of FIG. 16, the data transfer execution zone Z1, the handover execution zone Z2, and the forced handover execution zone Z4 may be set in an overlapping area of the cell #1 and the cell #2.

When the mobile device 4 moves to the data transfer execution zone Z1, the edge DC #1 belonging to the cell #1 may transfer the data addressed to the mobile device 4 to the edge DC #2 belonging to the cell #2.

When the mobile device 4 moves to the handover execution zone Z2 and when transfer of the data addressed to the mobile device 4 is completed, the eNB #1 belonging to the cell #1 may hand over the mobile device 4 to the eNBs #2 belonging to the cell #2.

When the mobile device 4 moves to the forced handover execution zone Z4, the eNB #1 belonging to the cell #1 may hand over the mobile device 4 to the eNBs #2 belonging to the cell #2, irrespective of whether or not the transfer of the data addressed to the mobile device 4 is completed.

In the graph illustrated in (2) of FIG. 16, the horizontal axis represents distance from the eNB #1 to the mobile device 4 and the vertical axis represents radio field strength between the eNBs #2 and the mobile device 4 that is measured by the mobile device 4.

As illustrated in (2) of FIG. 16, as distance between the eNB #1 and the mobile device 4 increases, the radio field strength between the eNB #1 and the mobile device 4 decreases. On the other hand, as the distance between the eNB #1 and the mobile device 4 increases, the radio field strength between the eNB #2 and the mobile device 4 increases.

In the example illustrated in (2) of FIG. 16, when the distance between the eNB #1 and the mobile device 4 exceeds T1, the data transfer processing unit 22 of the eNB #1 may request the edge DC #1 to transfer the data addressed to the mobile device 4 to the edge DC #2 belonging to the cell #2. As illustrated in FIG. 17, the radio field strength for the eNB #2 in the data transfer execution zone Z1 is smaller than the radio field strength for the eNB #1. In addition, as illustrated in FIG. 17, the radio processing unit 21 of the eNB #1 may transmit a Measurement Control signal to the mobile device 4 to receive from the mobile device 4 a Measurement Report signal including information indicating the radio quality.

In the example illustrated in (2) of FIG. 16, when the distance between the eNB #1 and the mobile device 4 exceeds T2, the data transfer processing unit 22 of the eNB #1 may judge whether or not the transfer of the data addressed to the mobile device 4 is completed. As illustrated in FIG. 17, the radio field strength for the eNB #2 in the handover execution zone Z2 is larger than the radio field strength for the eNB #1.

When the radio field strength between the eNB #1 and the mobile device 4 is larger than the second threshold, the data transfer processing unit 22 of the eNB #1 may judge whether or not the transfer of the data addressed to the mobile device 4 is completed. Here, the second threshold represents start of processing to hand over the mobile device 4 from the cell #1 to the cell #2, in response to movement of the mobile device 4.

If the transfer of the data addressed to the mobile device 4 is not completed, as illustrated in FIG. 17, the radio processing unit 21 of the eNB #1 may transmit a Measurement Control signal to the mobile device 4 to receive from the mobile device 4 a Measurement Report signal including information indicating the radio quality.

On the other hand, if the transfer of the data addressed to the mobile device 4 is completed, as illustrated in FIG. 17, the handover processing unit 23 of the eNB #1 performs processing to hand over the mobile device 4 to the eNB #2 that forms the cell #2.

In the example illustrated in (2) of FIG. 16, when the distance between the eNB #1 and the mobile device 4 exceeds T, the value obtained by subtracting the radio field strength for the eNB #1 from the radio field strength for the eNB #2 is α (which may also be referred to as a “third threshold”) or larger. In this forced handover execution zone Z4, as illustrated in FIG. 17, the handover processing unit 23 of the eNB #1 performs processing to hand over the mobile device 4 to the eNB #2, irrespective of whether or not the transfer of the data addressed to the mobile device 4 is completed.

With this, the mobile device 4 moves out of a service area of the eNB #1, thereby avoiding loss of the eNB #2 with which the mobile device 4 may communicate.

In addition, when the radio field strength between the eNB #2 and the mobile device 4 is larger than the third threshold, the handover processing unit 23 of the eNB #1 may perform handover processing, irrespective of whether or not the transfer of the data addressed to the mobile device 4 is completed.

As illustrated in (1) of FIG. 16, the distance T1 may be determined based on distance from the eNB #1 to the end of the cell #2. In addition, the distance T2 may be determined based on distance from the eNB #1 to a line segment connecting with an intersection point of the cell #1 area and the cell #2 area. Furthermore, the distance T may be determined based on distance from the eNB #1 to the mobile device 4 when general handover processing is performed.

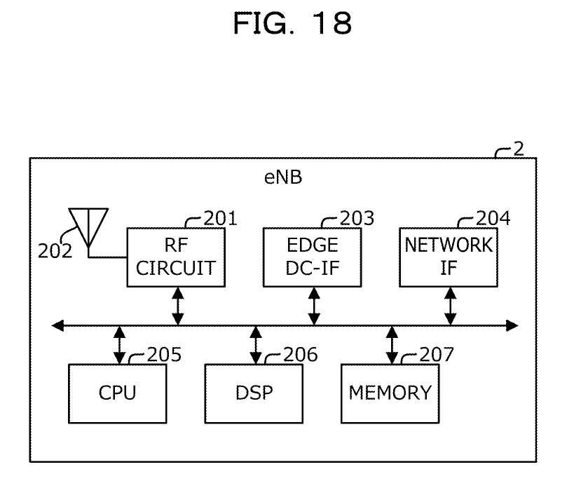

FIG. 18 is a hardware configuration diagram illustrating a hardware configuration example of the eNB #2 illustrated in FIG. 10.

The eNB #2 illustratively includes an RF circuit 201, an antenna 202, an edge DC-IF 203, a network IF 204, a CPU 205, a DSP 206, and a memory 207. Note that “RF” stands for “Radio Frequency”, “IF” stands for “Interface”, “CPU” stands for “Central Processing Unit”, and “DSP” stands for “Digital Signal Processor”.

The RF circuit 201 illustratively performs transmission and reception of a radio signal to and from the mobile device 4 by way of the antenna 202.

The edge DC-IF 203 illustratively connects the eNB #2 to the edge DC 3. As the edge DC-IF 203, various types of interface cards that comply with a communication standard between the eNB #2 and the edge DC 3 may be used.

The network IF 204 illustratively connects the eNB #2 to other eNB #2 by way of the x2 interface. The network IF 204 may also be connected to a core network (not illustrated). As the network IF 204, various interface cards that comply with a network standard may be used.

The CPU 205 is illustratively a processor configured to perform various controls or carries out an operation, and implements various functions by executing an OS or a program stored in the memory 207.

The DSP 206 is illustratively a microprocessor specialized in digital signal processing and implements various functions by executing the OS or the program stored in the memory 207.

The memory 207 is illustratively a storage device that includes at least one of a read only memory (ROM) and a random access memory (RAM). A program such as a basic input/output system (BIOS) or the like may be written into the ROM of the memory 207. A software program in the memory 207 may be appropriately read into the CPU 205 or the DSP 206 and executed. In addition, the RAM of the memory 207 may be utilized as a primary storage memory or a working memory.

Functions as the radio processing unit 21, the data transfer processing unit 22, and the handover processing unit 23 illustrated in FIG. 10 may be implemented by the CPU 205 or the DSP 206.

FIG. 19 is a hardware configuration diagram illustrating a hardware configuration example of the edge DC 3 illustrated in FIG. 10.

The edge DC 3 illustratively includes an auxiliary storage device 301, an eNB-IF 302, a network IF 303, a CPU 304, a DSP 305, and a memory 306.

The auxiliary storage device 301 is illustratively a device that stores data in a readable and writable manner. For example, a hard disk drive (HDD), a solid state drive (SSD), or a storage class memory (SCM) may be used. The auxiliary storage device 301 may store application data addressed to the mobile device 4.

The eNB-IF 302 illustratively connects the edge DC 3 to the eNB #2. As the eNB-IF 302, various interface cards that comply with a communication standard between the edge DC 3 and the eNB #2 may be used.

The network IF 303 illustratively connects the edge DC 3 to other edge DC 3 by way of Ethernet®. As the network IF 303, various types of interface cards that comply with the network standard may be used.

The CPU 304 is illustratively a processor configured to perform various controls or carries out an operation, and implements various function by executing an OS or a program stored in the memory 306.

The DSP 305 is illustratively a microprocessor specialized in digital signal processing, and implements various functions by executing the OS or the program stored in the memory 306.

The memory 306 is illustratively a storage device including at least one of a ROM and a RAM. A program such as BIOS or the like may be written in the ROM of the memory 306. A software program of the memory 306 may be appropriately read into the CPU 304 or the DSP 305 and executed. In addition, the RAM of the memory 306 may be used as a primary storage memory or a working memory.

Functions as the data transmission and reception unit 31 and the data processing unit 32 illustrated in FIG. 10 may be implemented by the CPU 304 or the DSP 305.

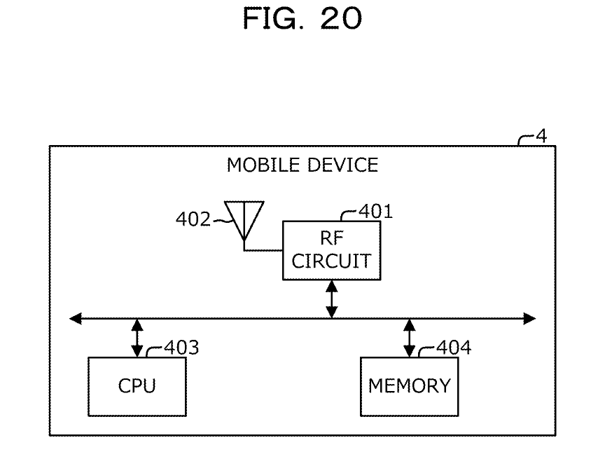

FIG. 20 is a hardware configuration diagram illustrating a hardware configuration example of the mobile device 4 illustrated in FIG. 10.

The mobile device 4 illustratively includes an RF circuit 401, an antenna 402, a CPU 403, and a memory 404.

The RF circuit 401 illustratively performs transmission and reception of a radio signal to and from the eNB #2 by way of the antenna 402.

The CPU 403 is illustratively a processor configured to perform various controls or carries out an operation, and implements various function by executing an OS or a program stored in the memory 404.

The memory 404 is illustratively a storage device including at least one of a ROM and a RAM. A program such as BIOS or the like may be written in the ROM of the memory 404. A software program of the memory 404 may be appropriately read into the CPU 403 and executed. In addition, the RAM of the memory 404 may be used as a primary storage memory or a working memory.

Functions as the radio processing unit 41 and the data transmission and reception unit 42 illustrated in FIG. 10 may be implemented by the CPU 403.

### [B-2] Operation Example

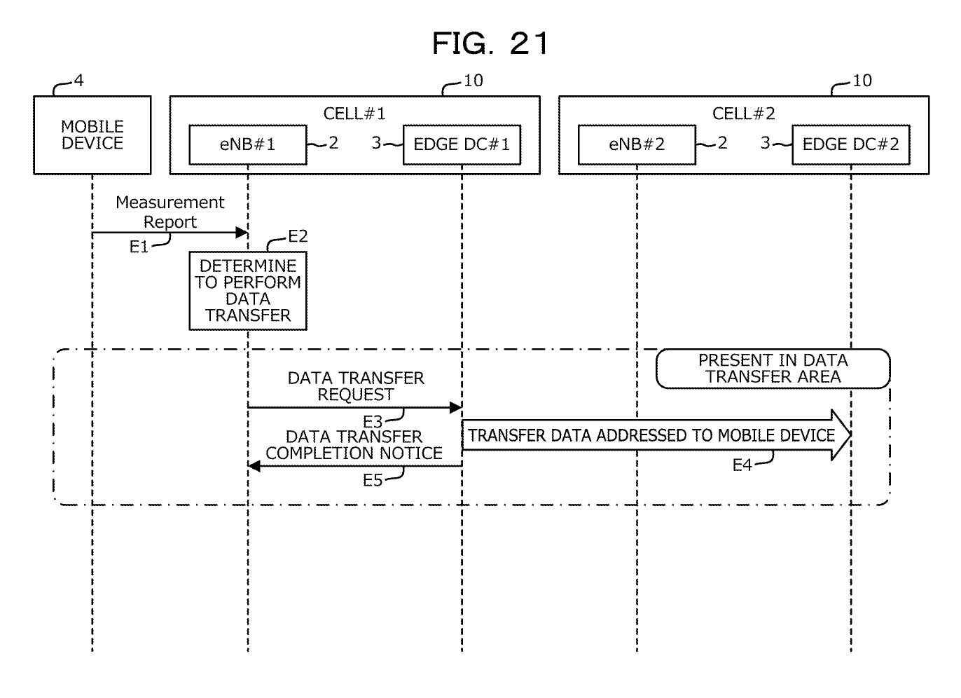

An example of a data transfer operation in the communication system 100 illustrated in FIG. 10 is descried following a sequence diagram (processing E1 to E5) illustrated in FIG. 21.

In processing E1, the mobile device 4 may transmit a Measurement Report signal to the eNB #1.

In processing E2, the eNB #1 may determine whether transfer to eNB #, of application data addressed to the mobile device 4, is performed.

When the mobile device 4 is present in the data transfer execution zone Z1, in the processing E3, the eNB #1 may make a data transfer request to the edge DC #1.

In processing E4, when receiving the data transfer request, the edge DC #1 may transfer the application data addressed to the mobile device 4 to the edge DC #2.

In processing E5, when the transfer of the application data addressed to the mobile device 4 is completed, the edge DC #1 may transmit a data transfer completion notice to the eNB #1. With this, the data transfer operation ends.

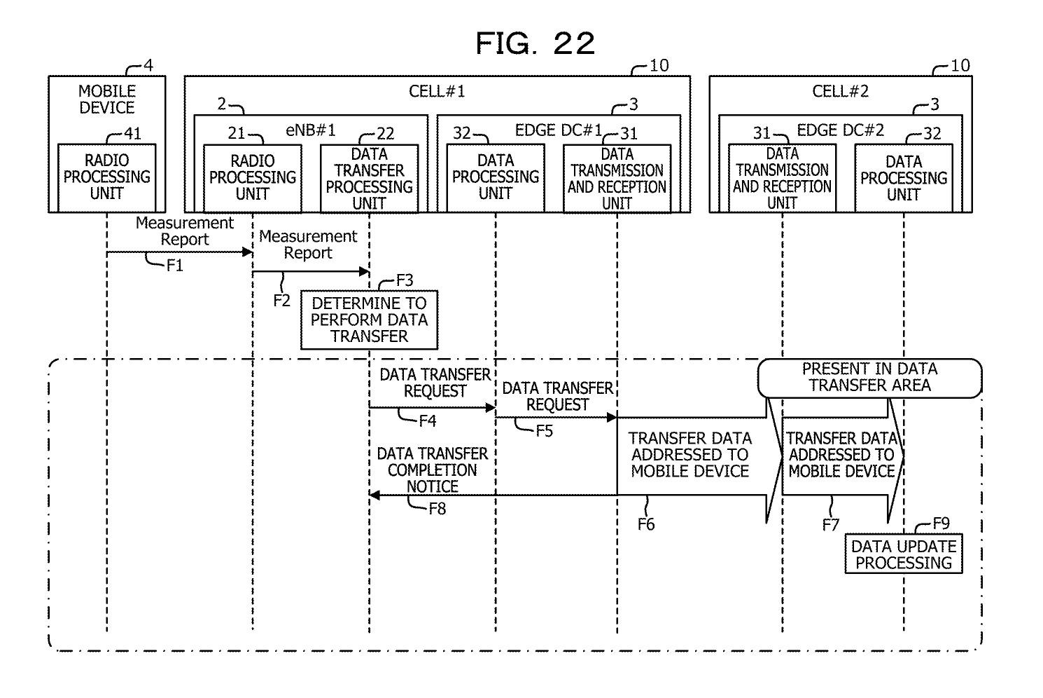

Details of the example of the data transfer operation illustrated in FIG. 21 are described following a sequence diagram (processing F1 to F9) illustrated in FIG. 22.

In processing F1, the radio processing unit 41 of the mobile device 4 may transmit a Measurement Report signal to the radio processing unit 41 of the eNB #1.

In processing F2, the radio processing unit 41 of the eNB #1 may transfer the received Measurement Report to the data transfer processing unit 22.

In processing F3, the data transfer processing unit 22 of the eNB #1 may determine whether transfer of the application data addressed to the mobile device 4 is performed, based on the received Measurement Report.

When the mobile device 4 is present in the data transfer execution zone Z1, in processing F4, the data transfer processing unit 22 may transmit a data transfer request to the data processing unit 32 of the edge DC #1.

In processing F5, the data processing unit 32 of the edge DC #1 may transfer the received data transfer request to the data transmission and reception unit 31.

In processing F6, when receiving the data transfer request, the data transmission and reception unit 31 of the edge DC #1 may transfer the application data addressed to the mobile device 4 to the data transmission and reception unit 31 of the edge DC #2.

In processing F7, the data transmission and reception unit 31 of the edge DC #2 may transfer the received application data addressed to the mobile device 4 to the data processing unit 32.

In processing F8, when the transfer of the application data addressed to the mobile device 4 to the edge DC #2, the data transmission and reception unit 31 of the edge DC #1 may transmit a data transfer completion notice to the data transfer processing unit 22 of the eNB #1.

In processing F9, the data processing unit 32 of the edge DC #2 may perform update processing of data stored in the auxiliary storage device 301 (see FIG. 19), based on the received application data addressed to the mobile device 4. With this, the data transfer operation ends.

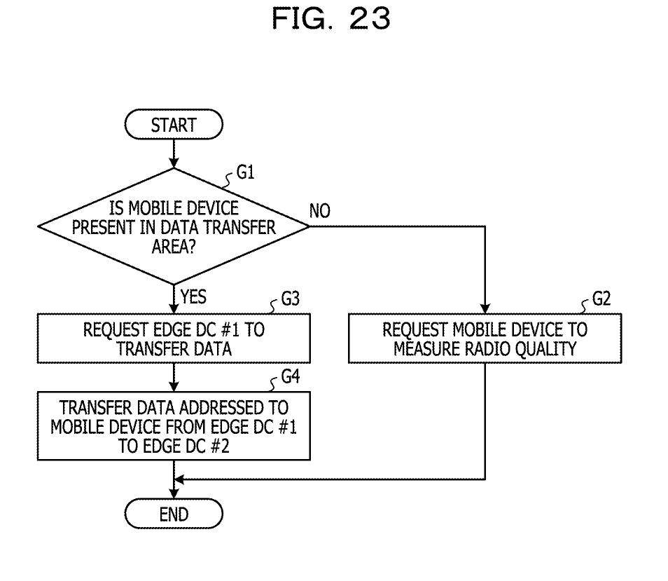

An example of a data transfer operation in the data transfer processing unit 22 of the eNB #1 at the data transfer source illustrated in FIG. 10 is described hereinafter following a flow chart (processing G1 to G4) illustrated in FIG. 23.

In processing G1, the data transfer processing unit 22 of the eNB #1 may judge whether the mobile device 4 is located in the data transfer execution zone Z1.

In No route of the processing G1, if the mobile device 4 is not present in the data transfer execution zone Z1, in processing G2, the data transfer processing unit 22 may request the mobile device 4 to measure the radio quality.

In Yes route of the processing G1, if the mobile device 4 is present in the data transfer execution zone Z1, in processing G3, the data transfer processing unit 22 may make a data transfer request to the edge DC #1 to transfer application data addressed to the mobile device 4.

In processing G4, the application data addressed to the mobile device 4 may be transferred from the edge DC #1 to the edge DC #2. With this, the data transfer operation is completed in the data transfer processing unit 22 of the eNB #1 at the data transfer source.

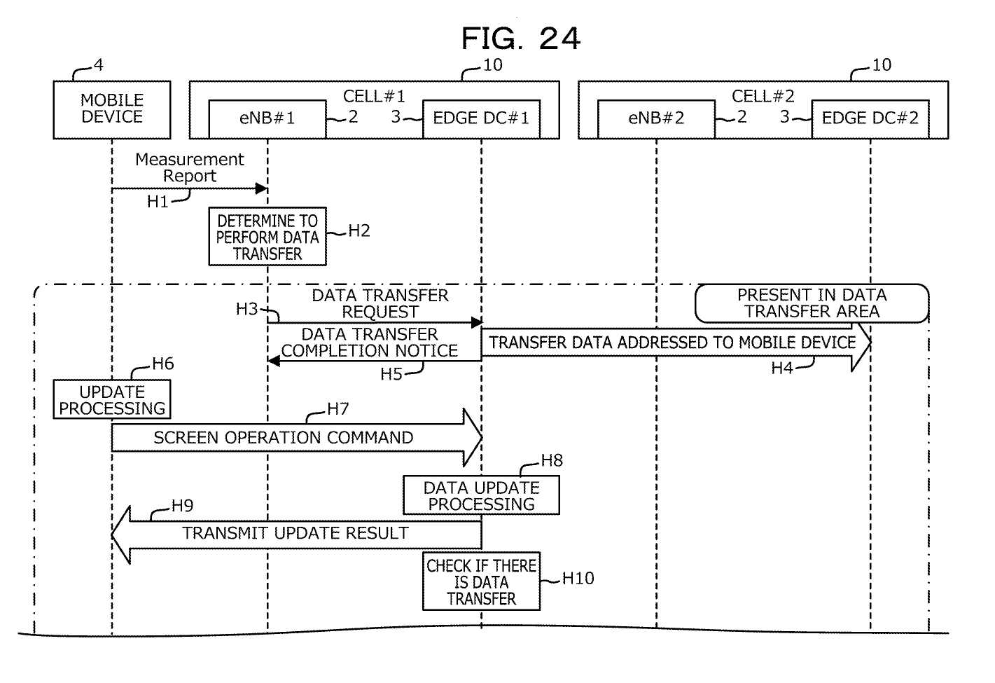

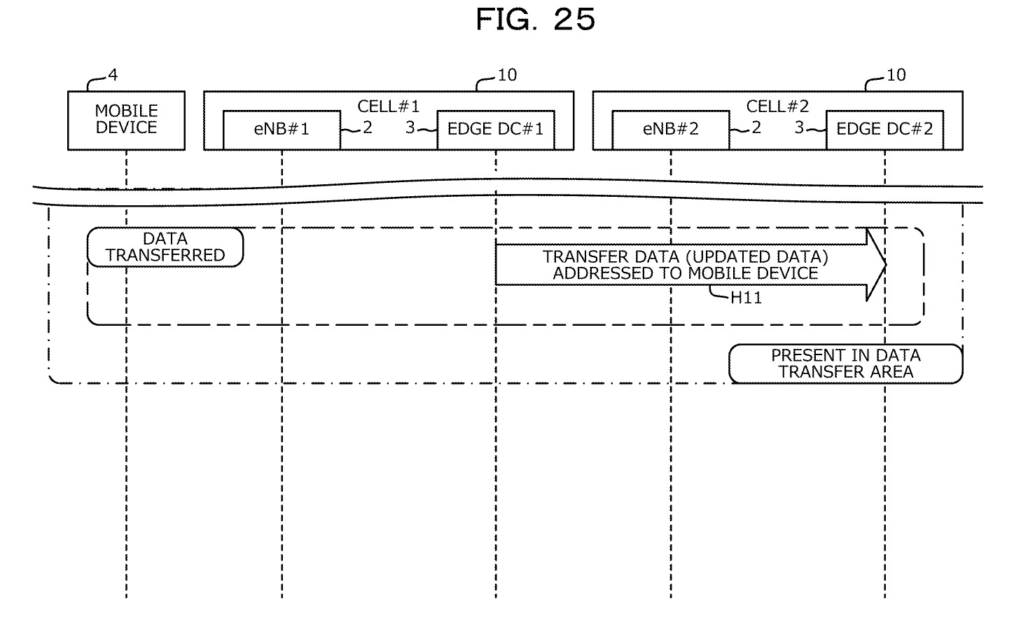

An updated data transfer operation in the communication system 100 illustrated in FIG. 10 is described hereinafter following a sequence diagram (processing H1 to H11) illustrated in FIGS. 24 and 25. Note that FIG. 24 illustrates processing H1 to H10 and FIG. 25 illustrates processing H11.

In processing H1 of FIG. 24, the mobile device 4 may transmit a Measurement Report signal to the eNB #1.

In processing H2 of FIG. 24, the eNB #1 may determine whether to transfer the application data addressed to the mobile device 4, based on the received Measurement Report signal.

When the mobile device 4 is present in the data transfer execution zone Z1, in processing H3 of FIG. 24, the eNB #1 may transmit a data transfer request to the edge DC #1.

In processing H4 of FIG. 24, when receiving the data transfer request, the edge DC #1 may transfer the application data addressed to the mobile device 4 to the edge DC #2.

In processing H5 of FIG. 24, when the transfer of the application data addressed to the mobile device 4 is completed, the edge DC #1 may transmit a data transfer completion notice to the eNB #1.

In processing H6 of FIG. 24, an update operation of the application data for the mobile device 4 may be performed by a user. An update operation is, for example, an operation to move or click on the mouse, or an operation to save a file.

In processing H7 of FIG. 24, the mobile device 4 may transmit a screen operation command to the edge DC #1 by way of the eNB #1, based on the update operation by the user.

In processing H8 of FIG. 24, the edge DC #1 may perform update processing of application data stored in the auxiliary storage device 301 (see FIG. 19) based on the received screen operation command.

In processing H9 of FIG. 24, the edge DC #1 may transmit an update result to the mobile device 4 by way of the eNB #1.

In processing of H10 of FIG. 24, the edge DC #1 may check if data transfer is already performed. Processing H10 may be performed triggered by screen operation such as movement of the mouse or the like, or triggered by saving of a file.

In this example, since data transfer is already performed in processing H4 of FIG. 24, in processing H11 of FIG. 25, the edge DC #1 may transfer to the edge DC #2 a difference between the data after being updated and the data before being updated. With this, the updated data transfer operation is completed.

Processing H1 of FIG. 24 to processing H11 of FIG. 25 may be performed repeatedly until handover processing is performed.

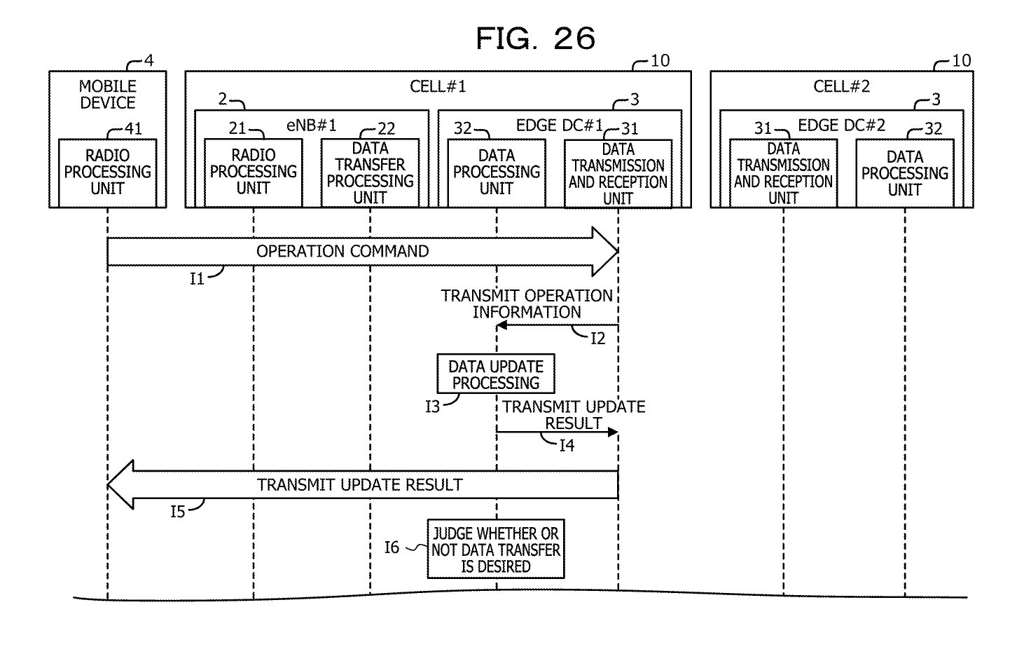

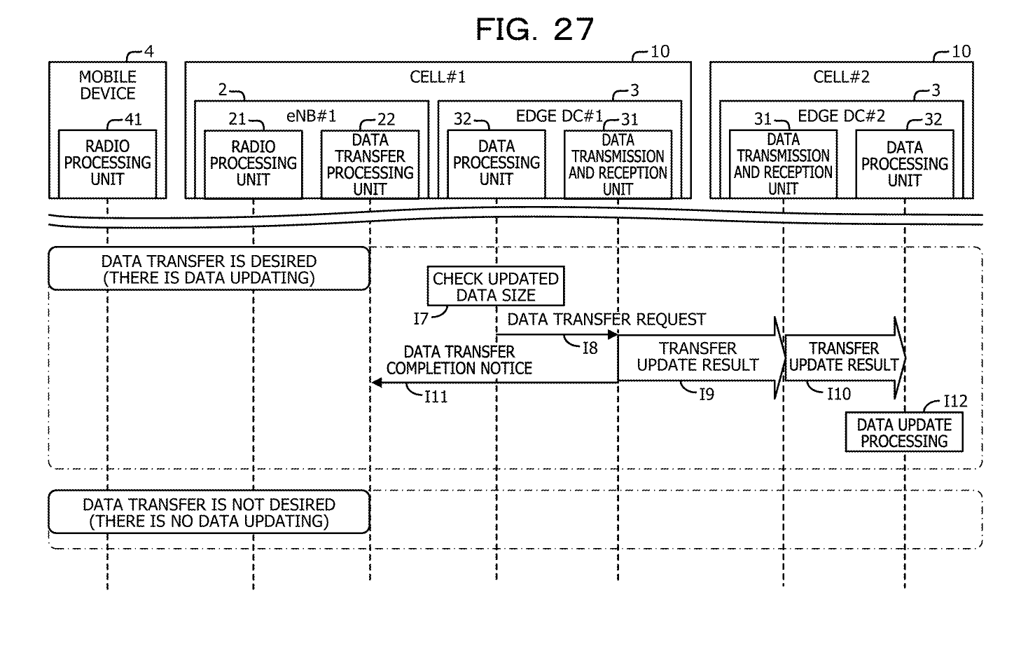

Details of the example of the updated data transfer operation illustrated in FIGS. 24 and 25 are described hereinafter following a sequence diagram (processing I11 to I12) illustrated in FIGS. 26 and 27. Note that FIG. 26 illustrates processing I1 to 116 and FIG. 27 illustrates processing I7 to I12.

In processing I1 of FIG. 26, the radio processing unit 41 of the mobile device 4 may transmit an operation command to the data transmission and reception unit 31 of the edge DC #1, by way of eNB #1.

In processing I2 of FIG. 26, the data transmission and reception unit 31 of the edge DC #1 may transmit operation information to the data processing unit 32, based on the received operation command.

In processing I3 of FIG. 26, the data processing unit 32 of the edge DC #1 may perform update processing of application data stored in the auxiliary storage device 301 (see FIG. 19) based on the received operation information.

In processing I4 of FIG. 26, the data processing unit 32 of the edge DC #1 may perform processing based on the received operation information and transmit an update result to the data transmission and reception unit 31.

In processing I5 of FIG. 26, the data transmission and reception unit 31 of the edge DC #1 may transmit the received update result to the radio processing unit 41 of the mobile device 4, by way of the eNB #1.

In processing I6 of FIG. 26, the data processing unit 32 of the edge DC #1 may judge whether transfer of the application data addressed to the mobile device 4 is desired.

If the data transfer is desired (in other words, “if there is data update”), in processing I7 of FIG. 27, the data processing unit 32 of the edge DC #1 may check size of updated data.

In processing I8 of FIG. 27, the data processing unit 32 may transmit a data transfer request to the data transmission and reception unit 31, based on the checked size of the updated data.

In processing I9 of FIG. 27, the data transmission and reception unit 31 of the edge DC #1 may transfer an update result to the data transmission and reception unit 31 of the edge DC #2, based on the received data transfer request.

In processing I10 of FIG. 27, the data transmission and reception unit 31 of the edge DC #2 may transfer the received update result to the data processing unit 32.

In processing I11 of FIG. 27, when the transfer of the update result is completed, the data transmission and reception unit 31 of the edge DC #1 may transmit a data transfer completion notice to the data transfer processing unit 22 of the eNB #1.

In processing I12 of FIG. 27, the data processing unit 32 of the edge DC #2 may perform data update processing based on the received update result. With this, the updated data transfer operation ends.

In addition, if data transfer is not desired (in other words, “if there is no data update”), the updated data transfer operation may end as long as processing I6 of FIG. 26 is completed.

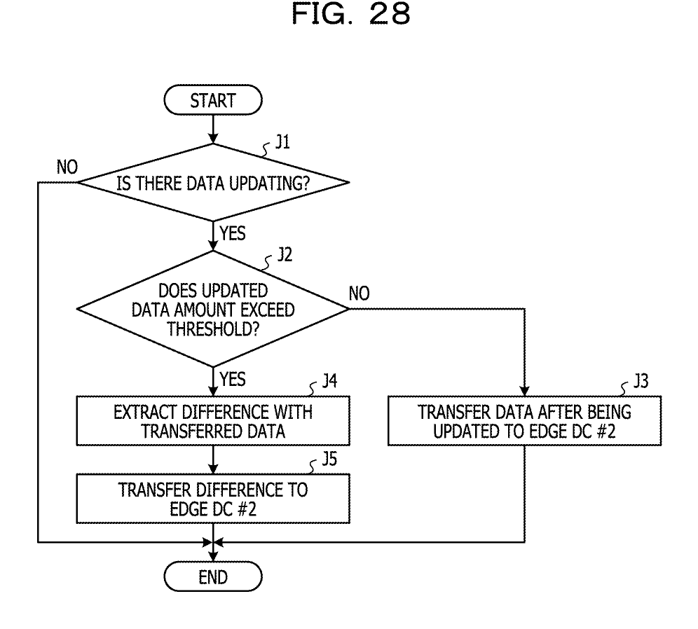

An updated data transfer operation in the data processing unit 32 of the edge DC #1 at the data transfer source illustrated in FIG. 10 is described hereinafter following a flow chart (processing J1 to J5) illustrated in FIG. 28.

In processing J1, the data processing unit 32 of the edge DC #1 may judge whether there is data update (in other words, “whether data transfer is desired”).

In No route of processing J1, if there is no data update, the updated data transfer operation at the data processing unit 32 may end.

On the other hand, in Yes route of processing J1, if there is data update, in processing J2, the data processing unit 32 may judge whether an updated data amount exceeds a threshold.

In No route of processing J2, if the updated data amount does not exceed the threshold, in processing J3, the data processing unit 32 may request the data transmission and reception unit 31 to transfer data after being updated to the edge DC #2.

On the other hand, in Yes route of processing J2, if the updated data amount exceeds the threshold, in processing J4, the data processing unit 32 may extract a difference between the data after being updated and the transferred data.

In processing J5, the data processing unit 32 may request the data transmission and reception unit 31 to transfer the extracted difference to the edge DC #1. With this, the updated data transfer operation in the data processing unit 32 may end.

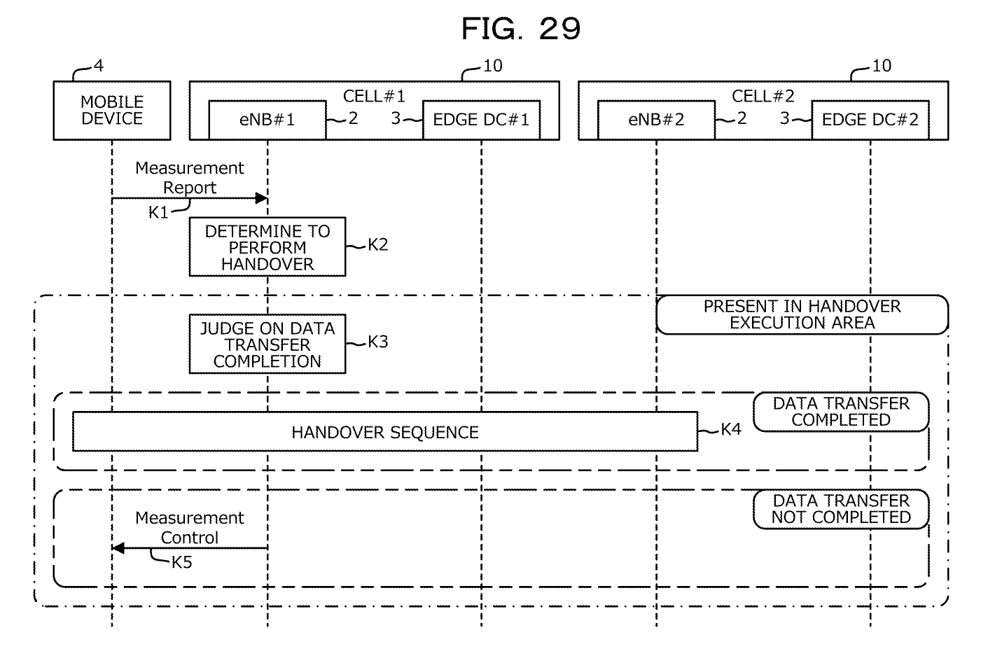

A handover processing example at the communication system 100 illustrated in FIG. 10 is described hereinafter following a sequence diagram (processing K1 to K5) illustrated in FIG. 29.

In processing K1, the mobile device 4 may transmit a Measurement Report signal to the eNB #1.

In processing K2, the eNB #1 may determine whether to perform handover, based on the received Measurement Report signal.

If the mobile device 4 is present in the handover execution zone Z2, in processing K3, the eNB #1 may judge whether data transfer is completed.

If the data transfer is completed, in processing K4, the eNB #1 may perform a handover sequence to hand over the mobile device 4 to the eNB #1. With this, the handover processing may completed.

On the other hand, if the data transfer is not completed, in processing K5, the eNB #1 may transmit a Measurement Control signal to the mobile device 4. Then, processing after processing K1 may be performed again.

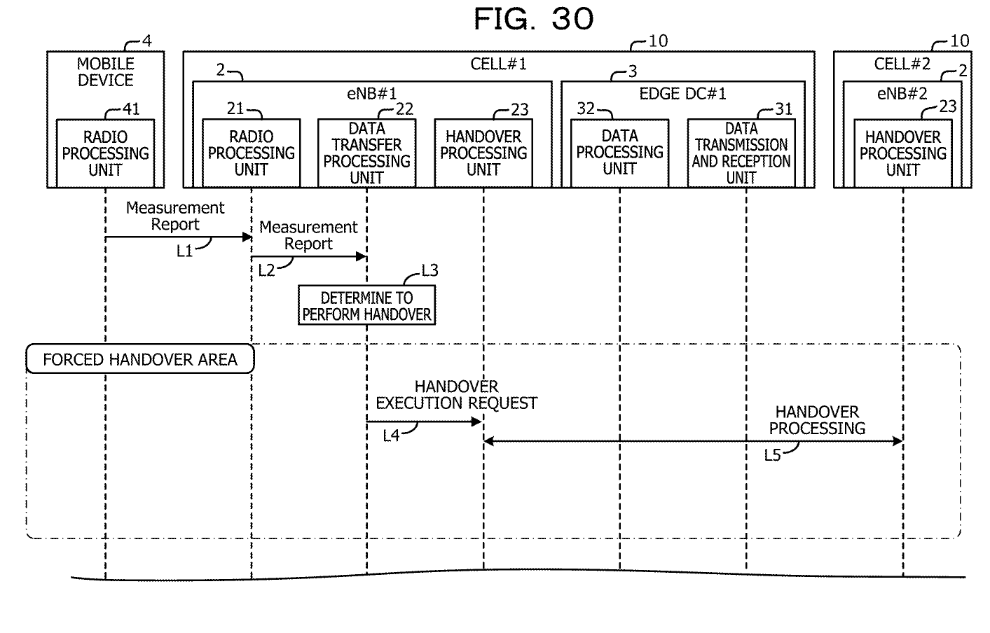

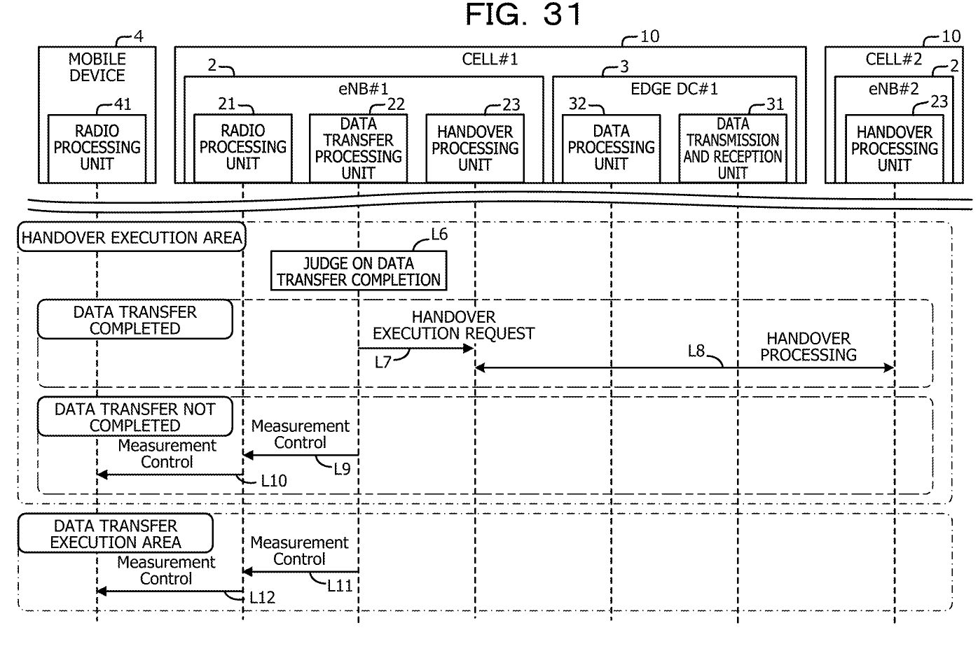

Details of the handover processing illustrated in FIG. 29 are described hereinafter following a sequence diagram (processing L1 to L12) illustrated in FIGS. 30 and 31. Note that FIG. 30 illustrates processing L1 to L5 and FIG. 31 illustrates processing L6 to L12.

In processing L1 of FIG. 30, the radio processing unit 41 of the mobile device 4 may transfer a Measurement Report signal to the radio processing unit 21 of the eNB #1.

In processing L2 of FIG. 30, the radio processing unit 21 of the eNB #1 may transfer the received Measurement Report signal to the data transfer processing unit 22.

In processing L3 of FIG. 30, the data transfer processing unit 22 of the eNB #1 may make a determination on whether to perform handover, based on the received Measurement Report signal.

When the mobile device 4 is present in the forced handover execution zone Z4, in processing L4 of FIG. 30, the data transfer processing unit 22 may transmit a handover execution request to the handover processing unit 23, irrespective of whether data transfer processing is completed.

In processing L5 of FIG. 30, the handover processing unit 23 of the eNB #1 may perform the handover processing to hand over the mobile device 4 to the eNB #2, with the handover processing unit 23 of the eNB #2, based on the received handover execution request. With this, the handover processing ends.

When the mobile device 4 is present in the handover execution zone Z2, in processing L6 of FIG. 31, the data transfer processing unit 22 of the eNB #1 may judge whether data transfer is completed.

If the data transfer is completed, in processing L7 of FIG. 31, the data transfer processing unit 22 may transmit a handover execution request to the handover processing unit 23.

In processing L8 of FIG. 31, the handover processing unit 23 of the eNB #1 may perform the handover processing to hand over the mobile device 4 to the eNB #2 with the handover processing unit 23 of the eNB #2, based on the received handover execution request. With this, the handover processing ends.

If the data transfer is not completed, in processing L9 of FIG. 31, the data transfer processing unit 22 may transmit a Measurement Control signal to the radio processing unit 21.

In processing L10 of FIG. 31, the radio processing unit 21 of the eNB #1 may transfer the received Measurement Control signal to the radio processing unit 41 of the mobile device 4. With this, the handover processing ends.

If the mobile device 4 is present in the data transfer execution zone Z1, in processing L11 of FIG. 31, the data transfer processing unit 22 may transmit a Measurement Control signal to the radio processing unit 21.

In processing L12 of FIG. 31, the radio processing unit 21 of the eNB #1 may transfer the received Measurement Control signal to the radio processing unit 41 of the mobile device 4. With this, the handover processing ends.

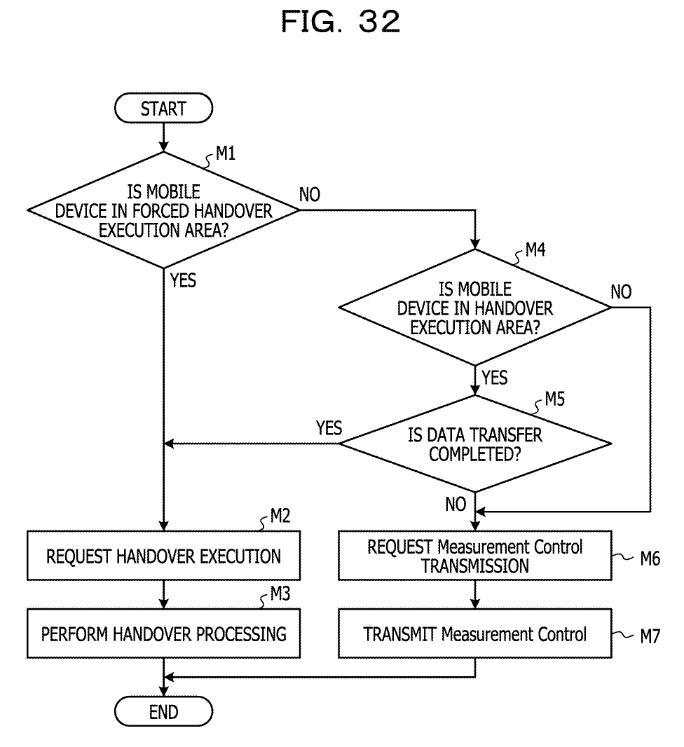

An example of handover processing in the data transfer processing unit 22 of the eNB #1 at the handover source illustrated in FIG. 10 is described hereinafter following a flow chart (processing M1 to M7) illustrated in FIG. 32.

In processing M1, the data transfer processing unit 22 of the eNB #1 may judge whether the mobile device 4 is present in the forced handover execution zone Z4.

In Yes route of processing M1, when the mobile device 4 is present in the forced handover execution zone Z4, in processing M2, the data transfer processing unit 22 may request the handover processing unit 23 to perform handover.

In processing M3, the handover processing unit 23 may perform the handover processing of the mobile device 4 from the eNB #1 to the eNB #2. With this, the handover processing in the data transfer processing unit 22 may end.

In No route of processing M1, if the mobile device 4 is not present in the forced handover execution zone Z4, in processing M4, the data transfer processing unit 22 may judge whether the mobile device 4 is present in the handover execution zone Z2.

In No route of processing M4, if the mobile device 4 is not present in the handover execution zone Z2, processing may proceed to processing M6.

On the other hand, in Yes route of processing M4, if the mobile device 4 is present in the handover execution zone Z2, in processing M5, the data transfer processing unit 22 may judge whether the data transfer is completed.

In Yes route of processing M5, if the data transfer is completed, processing may proceed to processing M2.

On the other hand, in No route of processing M5, if the data transfer is not completed, in processing M6, the data transfer processing unit 22 may request the radio processing unit 21 to transmit a Measurement Control signal.

In processing M7, a Measurement Control signal may be transmitted to the mobile device 4 by the radio processing unit 21 of the eNB #1. With this, the handover processing in the data transfer processing unit 22 may end.

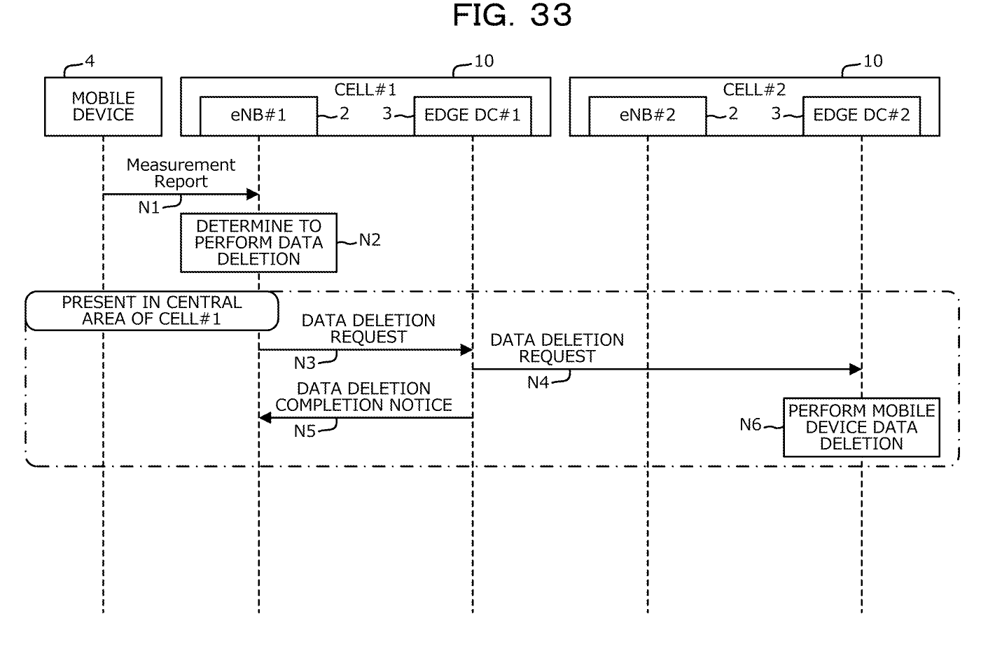

An example of data deletion operation in the communication system 100 illustrated in FIG. 10 is described hereinafter following a sequence diagram (processing N1 to N6) illustrated in FIG. 33.

In processing N1, the mobile device 4 may transmit a Measurement Report signal to the eNB #1.

In processing N2, the eNB #1 may determine whether to perform data deletion, based on the received Measurement Report signal.

When the mobile device 4 is present in the central area of the cell #1, in processing N3, the eNB #1 may transmit a data deletion request to the edge DC #1.

In processing N4, the edge DC #1 may transfer the received data deletion request to the edge DC #2.

In processing N5, when transfer of a data transfer request is completed, the edge DC #1 may transmit a data deletion completion notice to the eNB #1.

In processing N6, the edge DC #2 may perform data deletion of application data addressed to the mobile device 4 based on the received data deletion request. With this, the data deletion operation may end.

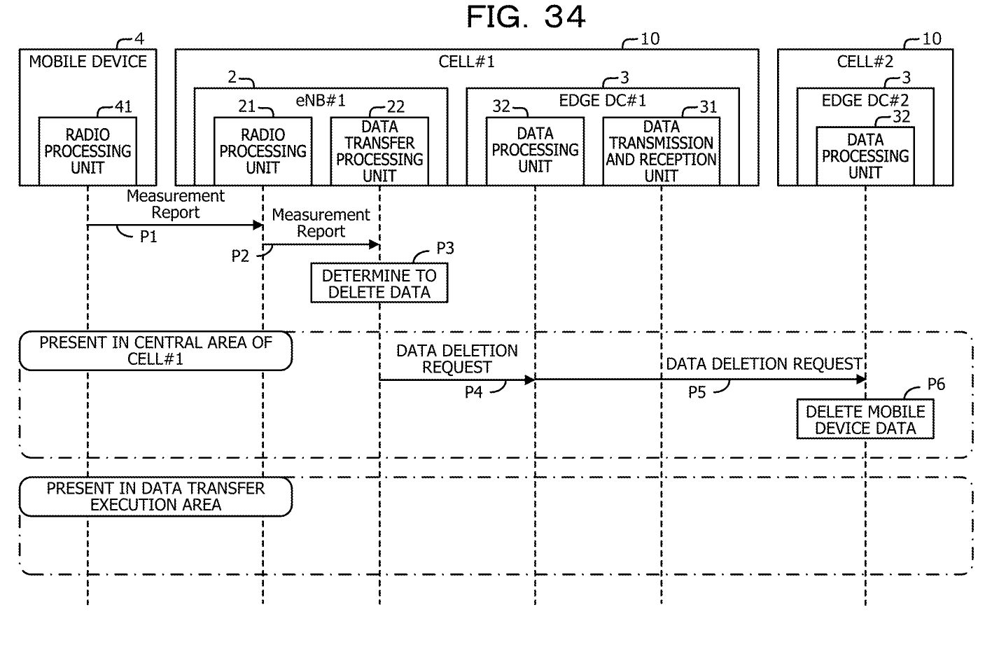

An example of a data deletion operation in the edge DC #2 at a data transfer destination of the communication system 100 illustrated in FIG. 10 is described hereinafter following a sequence diagram (processing P1 to P6) illustrated in FIG. 34.

In processing P1, the radio processing unit 41 of the mobile device 4 may transmit a Measurement Report signal to the radio processing unit 21 of the eNB #1.

In processing P2, the radio processing unit 21 of the eNB #1 may transfer the received Measurement Report signal to the data transfer processing unit 22.

In processing P3, the data transfer processing unit 22 of the eNB #1 may determine whether to delete data.

If the mobile device 4 is in the central area of the cell #1, in processing P4, the data transfer processing unit 22 may transmit a data deletion request to the data processing unit 32 of the edge DC #1.

In processing P5, the data processing unit 32 of the edge DC #1 may transfer the received data deletion request to the data processing unit 32 of the edge DC #2.

In processing P6, the data processing unit 32 of the edge DC #2 may delete application data addressed to the mobile device 4, based on the received data deletion request. With this, the data deletion operation at the edge DC #2 may completed.

When the mobile device 4 is present in the data transfer execution zone Z1, after processing P3, the data deletion operation at the edge DC #2 does not have to be performed.

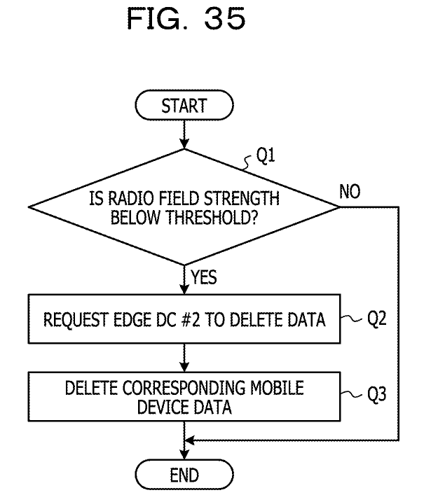

An example of data deletion determination for the edge DC #2 of a data transfer destination in the eNB #1 at a data transfer source illustrated in FIG. 10 is described hereinafter following a flow chart (processing Q1 to Q3) illustrated in FIG. 35.

In processing Q1, the data transfer processing unit 22 of the eNB #1 may judge whether radio field strength between the mobile device 4 and the eNB #2 is below a threshold (in other words, “whether the mobile device 4 is present in the central area of the cell #1”).

In No route of processing Q1, if the radio field strength is not below the threshold, the data deletion determination for the edge DC #2 may end.

On the other hand, in Yes route of processing Q1, if the radio field strength is below the threshold, in processing Q2, the data transfer processing unit 22 may request the edge DC #2 to delete application data addressed to the mobile device 4, by way of the edge DC #1.

In processing Q3, the application data addressed to the mobile device 4 in the edge DC #2 may be deleted. With this, the data deletion determination on the edge DC #2 may end.

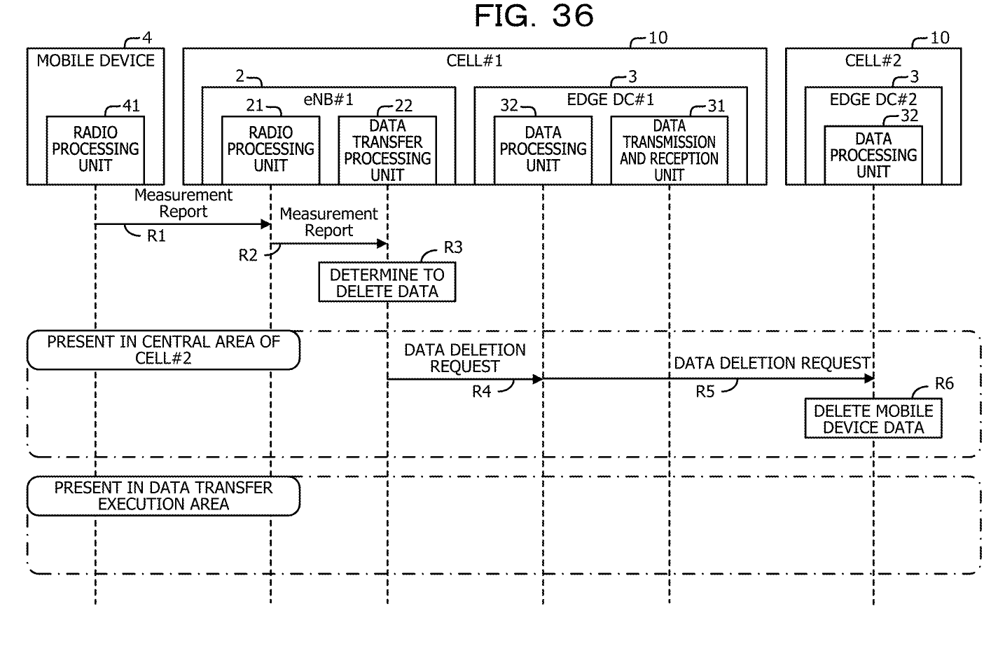

A data deletion operation in the edge DC #1 at a data transfer source of the communication system 100 illustrated in FIG. 10 is described hereinafter following a sequence diagram (processing R1 to R6) illustrated in FIG. 36.

In processing R1, the radio processing unit 41 of the mobile device 4 may transmit a Measurement Report signal to the radio processing unit 21 of the eNB #2.

In processing R2, the radio processing unit 21 of the eNB #2 may transfer the received Measurement Report signal to the data transfer processing unit 22.

In processing R3, the data transfer processing unit 22 of the eNB #2 may determine whether to perform data deletion.

When the mobile device 4 is present in the central area of the cell #2, in processing R4, the data transfer processing unit 22 may transmit a data deletion request to the data processing unit 32 of the edge DC #2.

In processing R5, the data processing unit 32 of the edge DC #2 may transfer the received data deletion request to the data processing unit 32 of the edge DC #1.

In processing R6, the data processing unit 32 of the edge DC #1 may delete application data addressed to the mobile device 4, based on the received data deletion request. With this, the data deletion operation in the edge DC #1 may completed.

When the mobile device 4 is present in the data transfer execution zone Z1, after processing R3, the data deletion operation in the edge DC #1 does not have to be performed.

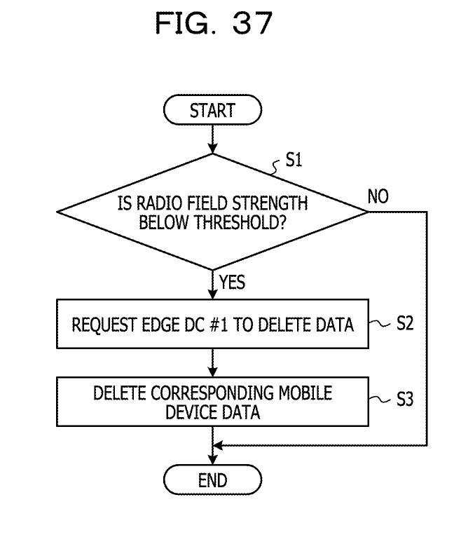

An example of data deletion determination on the edge DC #1 at a data transfer source in the eNB #2 at a data transfer destination illustrated in FIG. 10 is described hereinafter following a flow chart (processing S1 to S3) illustrated in FIG. 37.

In processing S1, the data transfer processing unit 22 of the eNB #2 may judge whether radio field strength between the mobile device 4 and the eNB #1 is below a threshold (in other words, “whether the mobile device 4 is present in the central area of the cell #2”).

In No route of processing S1, if the radio field strength is not below the threshold, the data deletion determination on the edge DC #1 may end.

On the other hand, in Yes route of processing S1, if the radio field strength is below the threshold, in processing S2, the data transfer processing unit 22 may request the edge DC #1 to delete the application data addressed to the mobile device 4, by way of the edge DC #2.

In processing S3, the application data addressed to the mobile device 4 in the edge DC #1 may be deleted. With this, the data deletion determination on the edge DC #1 may end.

### [C] Other

The disclosed technology is not limited to respective embodiments described above but may be varied and implemented in various ways to the extent that the disclosed technology does not depart from the intents of the respective embodiments. Each configuration and each processing of each embodiment may be selected where appropriate or may be combined appropriately.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method comprising:
performing a first communication between a first base station and a terminal device, wherein a first portion of data stored in a first storage device coupled to the first base station is transmitted to the terminal device in the first communication;
acquiring, by the first base station, first information and second information from the terminal device, wherein the first information indicates a first reception intensity of a first signal transmitted from the first base station, the second information indicates a second reception intensity of a second signal transmitted from a second base station, and the first information and the second information are determined by the terminal device;
transmitting, by the first base station, a second portion of the data from the first storage device to a second storage device coupled to the second base station based on a determination to transfer the second portion of the data;
determining, by the first base station, whether to change a communication destination of the first communication of the terminal device from the first base station to the second base station based on the first information and the second information;
changing the communication destination of the first communication of the terminal device from the first base station to the second base station after the data is transmitted from the first storage device to the second storage device; and
transmitting, by the second base station, at least a segment of the second portion of the data from the second storage device to the terminal device after the communication destination is changed from the first base station to the second base station.

2. The method according to claim 1, wherein
the communication destination is changed from the first base station to the second base station when the second reception intensity is greater than a first value, and
the first value is determined based on the second reception intensity when the terminal device is located at an end of a wireless area provided by the second base station.

3. The method according to claim 1, wherein
the communication destination is changed from the first base station to the second base station when a difference between the second reception intensity and the first reception intensity is equal to or greater than a second value.

4. The method according to claim 3, wherein
the communication destination is changed from the first base station to the second base station irrespective of whether transmission of the data from the first storage device to the second storage device is completed when the difference between the second reception intensity and the first reception intensity is equal to or greater than a third value which is greater than the second value.

5. The method according to claim 2, further comprising:
deleting, from the second storage device, the second portion of the data transmitted from the first storage device when the second reception intensity is equal to or less than a fourth value, wherein
the fourth value is a less than the first value.

6. The method according to claim 1, further comprising:
transmitting, from the first base station to the first storage device, a data transmission request which requests to transmit the second portion of the data from the first storage device to the second storage device; and
transmitting, from the first storage device to the second storage device, a difference between the second portion of the data after being updated and the second portion of the data before being updated when the second portion of the data is updated after the data transmission request is transmitted.

7. The method according to claim 2, further comprising:
acquiring, by the first base station, third information from the terminal device, wherein the third information indicates a third reception intensity of a third signal transmitted from a third base station and the third information is determined by the terminal device; and
transmitting the second portion of the data from the first storage device to the second storage device and a third storage device coupled to the third base station when a second difference between the second reception intensity and the third reception intensity is equal to or less than a fifth value and when the second reception intensity and the third reception intensity are equal to or greater than the first value.

8. The method according to claim 7, wherein
the second portion of the data is not transmitted from the first storage device to the third storage device when the second difference between the second reception intensity and the third reception intensity is greater than the fifth value and both of the second reception intensity and the third reception intensity are equal to or greater than the first value.

9. The method according to claim 1, wherein
the first storage device and the second storage device are respectively an edge data center for the first base station and the second base station.

10. The method according to claim 1, wherein
the determination to transfer the second portion of the data is executed by the first base station based on the second information.

11. A communication device comprising:
a memory; and
a processor coupled to the memory and configured to
perform a first communication between the base station and a terminal device, wherein a first portion of data stored in a storage device coupled to the base station is transmitted to the terminal device in the first communication,
acquire first information and second information from the terminal device, wherein the first information indicates a first reception intensity of a first signal transmitted from the base station, the second information indicates a second reception intensity of a second signal transmitted from another base station, and the first information and the second information are determined by the terminal device,
transmit a second portion of the data from the storage device to another storage device coupled to another base station based on a determination to transfer the second portion of the data,
determine whether to change a communication destination of the first communication of the terminal device from the base station to the another base station based on the first information and the second information, and
change the communication destination of the first communication of the terminal device from the base station to the another base station after the data is transmitted from the storage device to the another storage device, wherein
the another base station transmits at least a segment of the second portion of the data from the another storage device to the terminal device after the communication destination is changed from the base station to the another base station.

12. The communication device according to claim 11, wherein the processor is configured to
change the communication destination from the base station to the another base station when the second reception intensity is greater than a first value, and
the first value is determined based on the second reception intensity when the terminal device is located at an end of a wireless area provided by the another base station.

13. The communication device according to claim 11, wherein the processor is configured to
change the communication destination from the base station to the another base station when a difference between the second reception intensity and the first reception intensity is equal to or greater than a second value.

14. The communication device according to claim 13, wherein
the communication destination is changed from the base station to the another base station irrespective of whether transmission of the data from the storage device to the another storage device is completed when the difference between the second reception intensity and the first reception intensity is equal to or greater than a third value which is greater than the second value.

15. The communication device according to claim 12, wherein
the processor is configured to delete, from the another storage device, the second portion of the data transmitted from the storage device, when the second reception intensity is equal to or less than a fourth value, and
the fourth value is a less than the first value.

16. The communication device according to claim 11, wherein the processor is configured to:
transmit, to the storage device, a data transmission request which requests to transmit the second portion of the data from the storage device to the another storage device, and
transmit, from the storage device to the another storage device, a difference between the second portion of the data after being updated and the second portion of the data before being updated when the second portion of the data is updated after the data transmission request is transmitted.

17. The communication device according to claim 12, wherein the processor is configured to:
acquire third information from the terminal device, wherein the third information indicates a third reception intensity of a third signal transmitted from a third base station and is determined by the terminal device, and
transmit the second portion of the data from the storage device to the another storage device and a third storage device coupled to the third base station when a difference between the second reception intensity and the third reception intensity is equal to or less than a second predetermined value and the second reception intensity and the third reception intensity are equal to or greater than the predetermined value.

18. The communication device according to claim 17, wherein
the second portion of the data is not transmitted from the storage device to the third storage device when the difference between the second reception intensity and the third reception intensity is greater than the second predetermined value and the second reception intensity and the third reception intensity are equal to or greater than the predetermined value.

19. A communication system comprising:
a first base station; and
a second base station, wherein
the first base station performs a first communication between the first base station and a terminal device, wherein a first portion of data stored in a first storage device coupled to the first base station is transmitted to the terminal device in the first communication,
the first base station acquires first information and second information from the terminal device, wherein the first information indicates a first reception intensity of a first signal transmitted from the first base station, the second information indicates a second reception intensity of a second signal transmitted from the second base station, and the first information and the second information are determined by the terminal device,
the first base station transmits a second portion of the data from the first storage device to a second storage device coupled to the second base station based on a determination to transfer the second portion of the data,
the first base station determines whether to change a communication destination of the first communication of the terminal device from the first base station to the second base station based on the first information and the second information,
the first base station changes the communication destination of the first communication of the terminal device from the first base station to the second base station after the data is transmitted from the first storage device to the second storage device, and
the second base station transmits at least a segment of the second portion of the data from the second storage device to the terminal device after the communication destination is changed from the first base station to the second base station.

20. The communication system according to claim 19, wherein
the first base station determines to change the communication destination from the first base station to the second base station when the second reception intensity is greater than a predetermined value, and
the predetermined value is determined based on the second reception intensity when the terminal device is located at an end of a wireless area provided by the another base station.
